(19) United States
(12) Patent Application Publication
(10) Pub. No.: US 2025/0168085 A1
(43) Pub. Date: May 22, 2025

(54) QUALITY OF EXPERIENCE METRICS FOR A DUAL CONNECTIVITY MODE

(71) Applicant: QUALCOMM Incorporated, San Diego, CA (US)

(72) Inventors: Jianhua LIU, Beijing (CN); Shankar KRISHNAN, Poway, CA (US); Xipeng ZHU, San Diego, CA (US); Rajeev KUMAR, San Diego, CA (US)

(21) Appl. No.: 18/839,555

(22) PCT Filed: Apr. 29, 2022
(86) PCT No.: PCT/CN2022/090333

§ 371 Date: Aug. 19, 2024

(51) Int. Cl. H04L 41/5067; H04W 24/10; H04W 76/15

(52) U.S. Cl. CPC H04L 41/5067; H04W 24/10; H04W 76/15

(57) ABSTRACT

Various aspects of the present disclosure generally relate to wireless communication. In some aspects, a user equipment (UE) may receive, from at least one of a master node (MN) or a secondary node (SN), one or more radio access network visible quality of experience (RVQoE) configurations, wherein the UE is operating in a dual connectivity mode with the MN and the SN. The CE may transmit, to at least one of the MN or the SN, at least one RVQoE measurement report based at least in part on the one or more RVQoE configurations. Numerous other aspects are described.

### FIELD OF THE DISCLOSURE

Aspects of the present disclosure generally relate to wireless communication and to techniques and apparatuses for quality of experience metrics for a dual connectivity mode including radio access network visible quality of experience metrics for a dual connectivity mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from at least one of a master node (MN) or a secondary node (SN), one or more radio access network visible quality of experience (RVQoE) configurations, wherein the UE is operating in a dual connectivity mode with the MN and the SN. The method may include transmitting, to at least one of the MN or the SN, at least one RVQoE measurement report based at least in part on the one or more RVQoE configurations.

Some aspects described herein relate to a method of wireless communication performed by an MN. The method may include transmitting, to a UE, one or more RVQoE configurations, wherein the UE is operating in a dual connectivity mode with the MN and an SN. The method may include receiving, from the UE, at least one RVQoE measurement report based at least in part on the one or more RVQoE configurations.

Some aspects described herein relate to an apparatus for wireless communication at a UE. The apparatus may include a memory and one or more processors coupled to the memory. The one or more processors may be configured to receive, from at least one of an MN or an SN, one or more RVQoE configurations, wherein the UE is operating in a dual connectivity mode with the MN and the SN. The one or more processors may be configured to transmit, to at least one of the MN or the SN, at least one RVQoE measurement report based at least in part on the one or more RVQoE configurations.

Some aspects described herein relate to an apparatus for wireless communication at an MN. The apparatus may include a memory and one or more processors coupled to the memory. The one or more processors may be configured to transmit, to a UE, one or more RVQoE configurations, wherein the UE is operating in a dual connectivity mode with the MN and an SN. The one or more processors may be configured to receive, from the UE, at least one RVQoE measurement report based at least in part on the one or more RVQoE configurations.

Some aspects described herein relate to a non-transitory computer-readable medium that stores a set of instructions for wireless communication by a UE. The set of instructions, when executed by one or more processors of the UE, may cause the UE to receive, from at least one of an MN or an SN, one or more RVQoE configurations, wherein the UE is operating in a dual connectivity mode with the MN and the SN. The set of instructions, when executed by one or more processors of the UE, may cause the UE to transmit, to at least one of the MN or the SN, at least one RVQoE measurement report based at least in part on the one or more RVQoE configurations.

Some aspects described herein relate to a non-transitory computer-readable medium that stores a set of instructions for wireless communication by an MN. The set of instructions, when executed by one or more processors of the one or more instructions that, when executed by one or more processors of the MN, may cause the MN to transmit, to a UE, one or more RVQoE configurations, wherein the UE is operating in a dual connectivity mode with the MN and an SN. The set of instructions, when executed by one or more processors of the MN, may cause the MN to receive, from the UE, at least one RVQoE measurement report based at least in part on the one or more RVQoE configurations.

Some aspects described herein relate to an apparatus for wireless communication. The apparatus may include means for receiving, from at least one of an MN or an SN, one or more RVQoE configurations, wherein the apparatus is operating in a dual connectivity mode with the MN and the SN. The apparatus may include means for transmitting, to at least one of the MN or the SN, at least one RVQoE measurement report based at least in part on the one or more RVQoE configurations.

Some aspects described herein relate to an apparatus for wireless communication. The apparatus may include means for transmitting, to a UE, one or more RVQoE configurations, wherein the UE is operating in a dual connectivity mode with the apparatus and an SN. The apparatus may include means for receiving, from the UE, at least one RVQoE measurement report based at least in part on the one or more RVQoE configurations.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network architecture, in accordance with the present disclosure.

FIG. 4 is a diagram illustrating an example of dual connectivity, in accordance with the present disclosure.

FIG. 5 is a diagram illustrating an example of a quality of experience configuration and reporting procedure, in accordance with the present disclosure.

FIGS. 6-10 are diagrams illustrating examples associated with configuration of quality of experience and/or radio access network visible quality of experience measurements for a dual connectivity mode, in accordance with the present disclosure.

FIG. 11 is a diagram illustrating an example process performed, for example, by a UE, in accordance with the present disclosure.

FIG. 12 is a diagram illustrating an example process performed, for example, by a master node, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

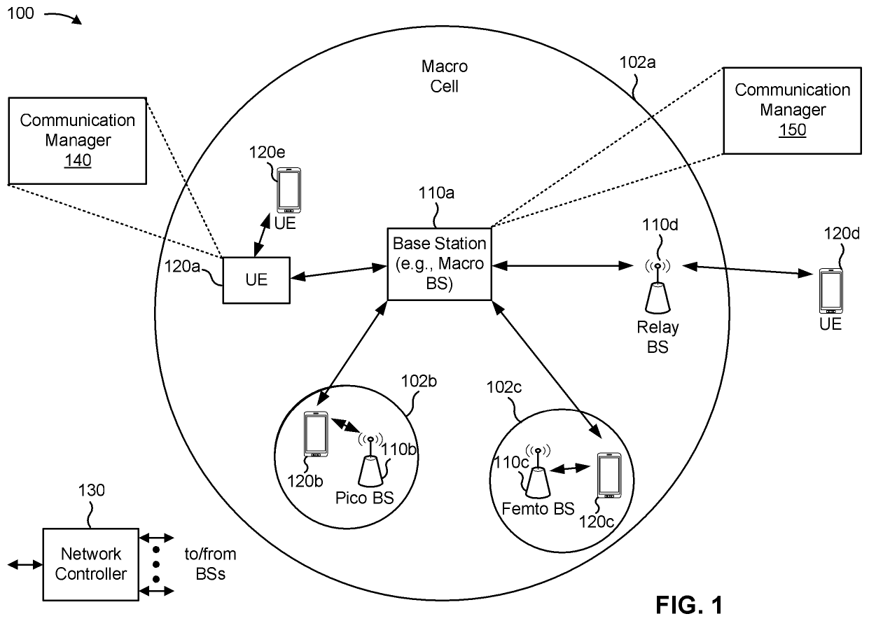

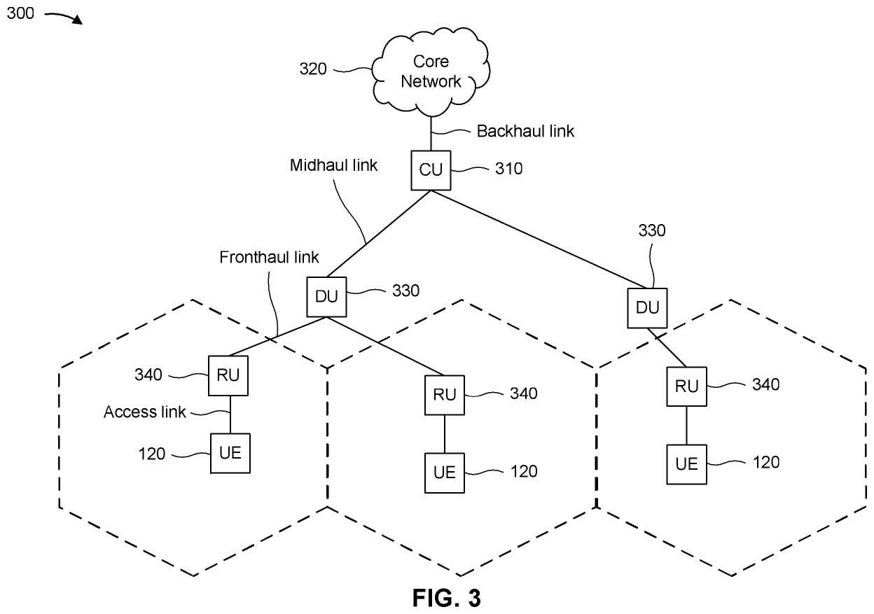

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although the base station 110 is shown as an integral unit in FIG. 1, aspects of the disclosure are not so limited. In some other aspects, the functionality of the base station 110 may be disaggregated according to an open radio access network (O-RAN) architecture or the like, which will be described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from at least one of a master node (MN) or a secondary node (SN), one or more radio access network visible quality of experience (RVQoE) configurations, wherein the UE is operating in a dual connectivity mode with the MN and the SN; and transmit, to at least one of the MN or the SN, at least one RVQoE measurement report based at least in part on the one or more RVQoE configurations. Additionally, or alternatively, the communication manager 140 may perform one or more other operations described herein.

In some aspects, the MN and/or the SN described elsewhere herein may correspond to the base station 110. The MN and/or the SN may include a communication manager 150. As described in more detail elsewhere herein, the communication manager 150 may transmit, to a UE (e.g., UE 120), one or more RVQoE configurations, wherein the UE is operating in a dual connectivity mode with the MN and a SN; and receive, from the UE, at least one RVQoE measurement report based at least in part on the one or more RVQoE configurations. Additionally, or alternatively, the communication manager 150 may perform one or more other operations described herein.

As indicated above, FIG. 1 is provided as an example. Other examples may differ from what is described with regard to FIG. 1.

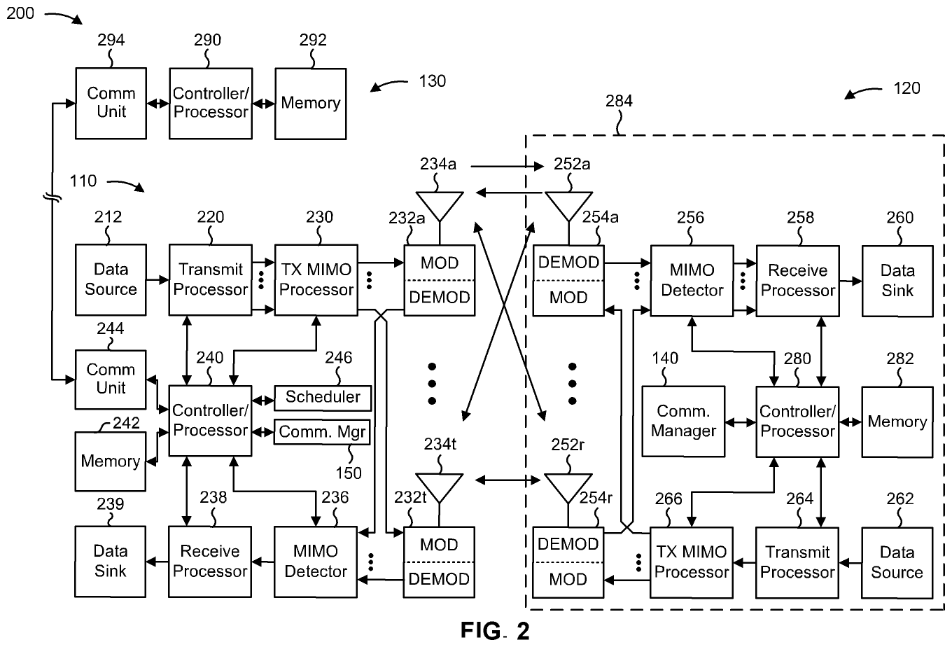

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

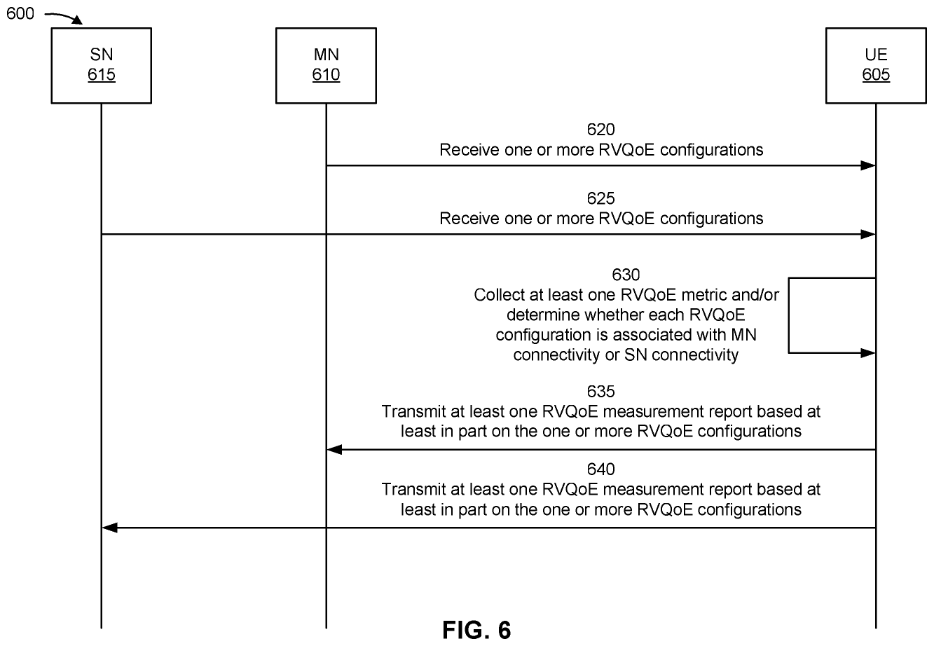

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-14).

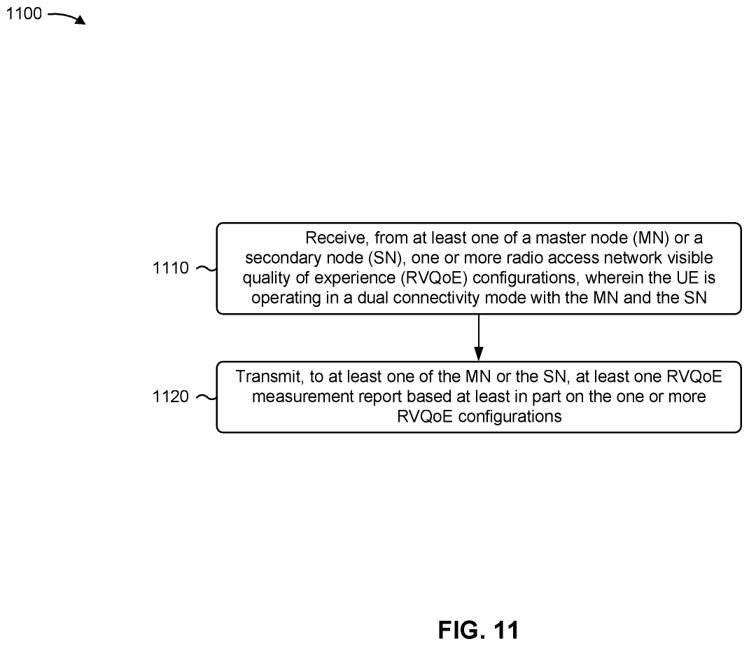

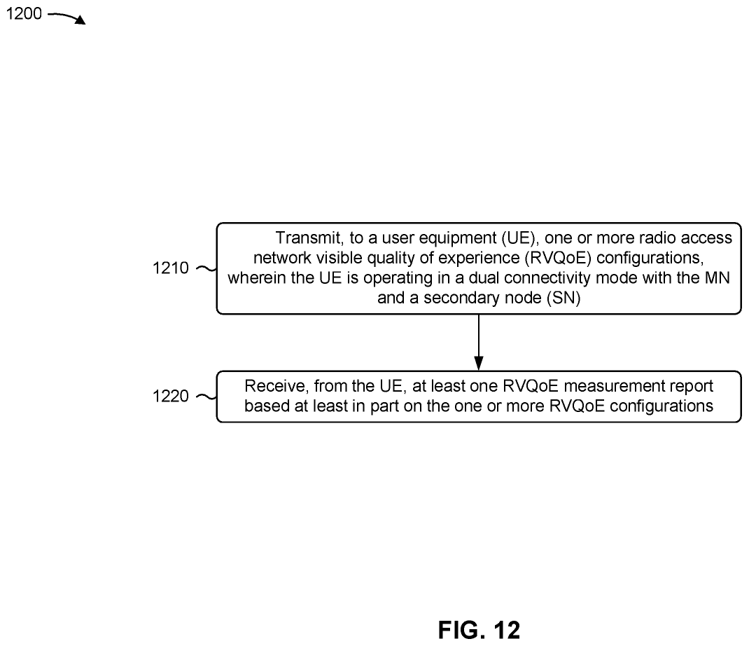

The controller/processor 240 of the base station 110, the controller/processor 280 of the UE 120, and/or any other component(s) of FIG. 2 may perform one or more techniques associated with RVQoE metrics for a dual connectivity mode, as described in more detail elsewhere herein. In some aspects, the MN described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving, from at least one of an MN or an SN, one or more RVQoE configurations, wherein the UE is operating in a dual connectivity mode with the MN and the SN; and/or means for transmitting, to at least one of the MN or the SN, at least one RVQoE measurement report based at least in part on the one or more RVQoE configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the MN (which may correspond to the base station 110) includes means for transmitting, to a UE (e.g., UE 120), one or more RVQoE configurations, wherein the UE is operating in a dual connectivity mode with the MN and an SN; and/or means for receiving, from the UE, at least one RVQoE measurement report based at least in part on the one or more RVQoE configurations. In some aspects, the means for the MN to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of an O-RAN architecture, in accordance with the present disclosure. As shown in FIG. 3, the O-RAN architecture may include a centralized unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

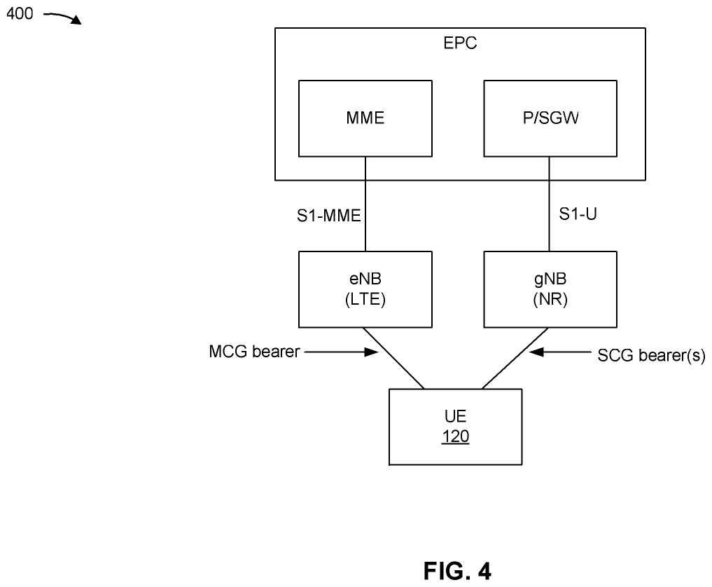

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture. In some aspects, a UE 120 may be operating in a dual connectivity mode with more than one base station 110, CU 310, DU 330, RU 340, or similar network node or entity, which is described in more detail in connection with FIG. 4, below.

As indicated above, FIG. 3 is provided as an example. Other examples may differ from what is described with regard to FIG. 3.

FIG. 4 is a diagram illustrating an example 400 of dual connectivity, in accordance with the present disclosure. The example shown in FIG. 4 is for an Evolved Universal Mobile Telecommunications System Terrestrial Radio Access (E-UTRA)-NR dual connectivity (ENDC) mode. In the ENDC mode, a UE 120 communicates using an LTE RAT on a master cell group (MCG), and the UE 120 communicates using an NR RAT on a secondary cell group (SCG). However, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

As shown in FIG. 4, a UE 120 may communicate with both an eNB (e.g., a 4G base station 110, CU 310, DU 330, RU 340, or other LTE network node or entity, which is sometimes referred to as an MN) and a gNB (e.g., a 5G base station 110, CU 310, DU 330, RU 340, or other 5G network node or entity, which is sometimes referred to as an SN)), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In an NRDC mode (e.g., a mode where both the MN and the SN are associated with a corresponding 5G base station 110, CU 310, DU 330, RU 340, or other network node or entity) or other dual connectivity mode, the MN and SN may communicate with a 5G core network that includes a multicell/multicast coordination entity (MCE), a trace collection entity (TCE), or similar devices. In FIG. 4, the PGW and the SGW are shown collectively as P/SGW. In some aspects, the eNB and the gNB may be co-located at the same base station 110 or other network entity. In some aspects, the eNB and the gNB may be included in different base stations 110 or network entities (e.g., may not be co-located).

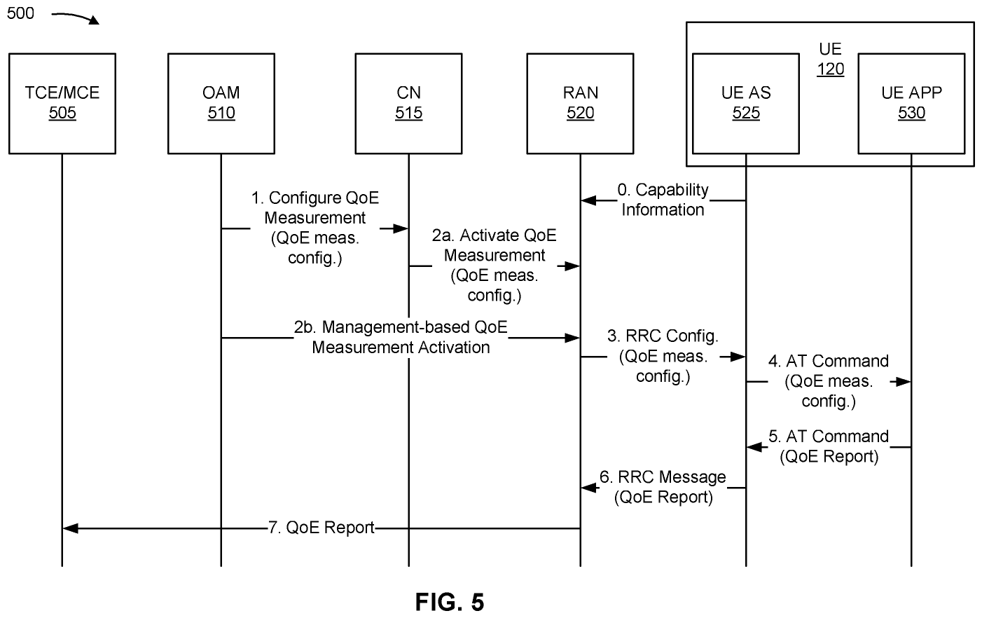

As further shown in FIG. 4, in some aspects, a wireless network that permits operation in a 5G NSA mode may permit such operations using a MCG for a first RAT (e.g., an LTE RAT or a 4G RAT in the depicted example, but which could be an NR RAT or a 5G RAT in other examples) and a SCG for a second RAT (e.g., an NR RAT or a 5G RAT). In this case, the UE 120 may communicate with the eNB via the MCG, and may communicate with the gNB via the SCG. In some aspects, the MCG may anchor a network connection between the UE 120 and the core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some other aspects, the MN and the SN may communicate with one another, as described in more detail in connection with FIG. 5. In some aspects, a UE 120 operating in a dual connectivity mode may be concurrently connected with an LTE base station 110 or other network entity (e.g., an eNB) and an NR base station 110 or other network entity (e.g., a gNB) (e.g., in the case of ENDC or NEDC), or may be concurrently connected with one or more base stations 110 or other network entities that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., RRC information and/or measurement reports) using one or more SRBs. In some aspects, one or more types of SRBs may be used to communicate between the UE 120 and the MN, while different one or more types of SRBs may be used to communicate between the UE 120 and the SN. For example, a type 0 SRB (e.g., SRB0), a type 1 SRB (e.g., SRB1), and/or a type 2 SRB (e.g., SRB2) may be used to communicate between the UE 120 and the MN, and a type 3 SRB (e.g., SRB3) may be used to communicate between the UE 120 and SN. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

In some aspects, a UE 120 may measure one or more quality of experience (QoE) metrics and report the measurements to one or more of the MN, the SN, and/or the core network via the MCG, the SCG, or both the MCG and the SCG. Aspects of QoE measurements are described in more detail in connection with FIG. 5.

As indicated above, FIG. 4 is provided as an example. Other examples may differ from what is described with respect to FIG. 4.

FIG. 5 is a diagram illustrating an example 500 of a QoE configuration and reporting procedure, in accordance with the present disclosure. As shown in FIG. 5, various network entities and devices, and layers within such devices, may communicate with one another over a wireless network (e.g., wireless network 100) or the like. For example, a TCE/MCE entity (e.g., TCE/MCE 505), an operations, administration, and management (OAM) entity (e.g., OAM 510), a core network (CN) entity (e.g., CN 515), a RAN entity (e.g., RAN 520) (which, in some aspects, may be an NG-RAN entity such as a base station 110, a CU 310, a DU 330, an RU 340, or a similar entity), a UE access stratum (AS) layer or entity (e.g., US AS 525), and/or a UE application (APP) layer or entity (e.g., UE APP 530) may communicate with one another. In some aspects, the UE AS 525 and the UE APP 530 may be associated with a UE 120.

As shown as step 0, the UE AS 525 may report UE 120 capability information to the RAN 520. For example, the capability information may be reported during an initial access procedure, and may include information regarding types of QoE metrics the UE 120 is capable of measuring, or the like. As shown as step 1, in a signaling-based NR QoE activation procedure, the OAM 510 may configure the CN 515 with QoE measurement information, sometimes referred to as a QoE measurement configuration. As shown as step 2a, in the signaling-based NR QoE activation procedure, the CN 515 may activate a QoE measurement procedure by forwarding the QoE measurement configuration to the RAN 520. Alternatively, in a management-based activation procedure, as shown as step 2b, the OAM 510 may activate the QoE measurement procedure by forwarding the QoE measurement configuration directly to the RAN 520. Put another way, in the signaling-based NR QoE activation procedure, the CN 515 may initiate the activation of QoE measurement, as configured by the OAM entity 510, while in the management-based NR QoE activation procedure, the RAN 520 may initiate the activation of QoE measurement, as configured by the OAM 510. In some aspects, the OAM 510 may configure and/or activate multiple simultaneous QoE measurements.

As shown by step 3, the RAN 520 may transmit an RRC configuration message to the UE 120 (and, more particularly, to the UE AS 525) that includes the QoE measurement configuration. As shown as step 4, the UE AS 525 may transmit an attention (AT) command or the like to the UE APP 530 that includes the QoE measurement configuration. The UE APP 530 may make one or more QoE measurements based at least in part on the QoE measurement configuration, and, as shown as step 5, the UE APP 530 may transmit an attention (AT) command or the like to the UE AS 525 that includes a QoE report including the one or more QoE measurements and/or one or more QoE metrics. As shown as step 6, the UE AS 525 may transmit an RRC message or the like to the RAN 520 that includes the QoE report. And as shown as step 7, the RAN 520 may transmit the QoE report to the TCE/MCE 505.

In such aspects, the QoE measurements may be provided from the UE 120 (and, more particularly, from the UE AS 525) to the RAN 520 inside zipped XML files or the like. In this regard, the QoE measurements are transparent to the RAN 520. However, in some aspects, the RAN 520 may need to utilize the QoE measurements at the RAN level. For example, it may be beneficial for the RAN 520 to utilize QoE measurements for purposes such as for QoE aware scheduling, QoE aware load balancing, link adaptation, mobility decision evaluation after a handover, and similar purposes. This requires that the RAN 520 parse, decode, and/or analyze the zipped XML files or the like in order to utilize the QoE measurements, which may be a cumbersome task. Moreover, when a UE (e.g., UE 120) is operating in a dual connectivity mode, such as described above in connection with FIG. 4, each QoE measurement may only be relevant to a RAN entity associated with the connectivity that a particular application is associated with, which may be cumbersome to determine by the RAN 520. Accordingly, the RAN 520 must expend lots of power, computing, and other resources in order to utilize the QoE measurements for purposes of QoE aware scheduling, QoE aware load balancing, link adaptation, mobility decision evaluation after a handover, and similar purposes, or else forgo using QoE measurements, resulting in inefficient use of network resources.

Some techniques and apparatuses described herein enable the configuration, receipt, and/or use of QoE measurements by one or more RAN entities connected to a UE operating in a dual connectivity mode or otherwise associated with a UE operating in a dual connectivity mode. More particularly, some techniques and apparatuses described herein enable RVQoE metrics, such that the measurements need not be parsed, decoded, or the like in order to utilize the QoE measurements at one or more RAN entities. Some techniques and apparatuses described herein enable one or more RAN entities operating in a dual connectivity mode (e.g., an MN and an SN) to configure QoE measurements by a UE to receive reports of the QoE measurements from the UE. In some aspects, a UE may receive, from at least one of an MN or an SN associated with a dual connectivity mode of the UE, one or more QoE and/or RVQoE configurations. For example, the UE may receive a common QoE and/or RVQoE configuration from one of the MN or the SN that is applicable to both the MN and the SN, the UE may receive an MN-specific QoE and/or RVQoE configuration and/or an SN-specific QoE and/or RVQoE configuration from one of the MN or the SN, or the UE may receive an MN-specific QoE and/or RVQoE configuration from the MN and an SN-specific QoE and/or RVQoE configuration from the SN. In some aspects, the UE may transmit, to at least one of the MN or the SN, at least one QoE and/or RVQoE measurement report based at least in part on the one or more QoE and/or RVQoE configurations. In this way, an MN or and/or an SN may efficiently configure a UE to perform QoE measurements. Moreover, an MN and/or an SN may receive one or more RVQoE measurement reports from a UE operating in a dual connectivity mode, thereby enabling QoE aware scheduling, QoE aware load balancing, link adaptation, mobility decision evaluation after a handover, and similar determinations. Accordingly, the UE, the MN, and/or the SN may conserve computing, power, network, and/or communication resources that may have otherwise been consumed parsing, decoding, and analyzing QoE measurement information, and one or more network entities may beneficially utilize QoE measurements in making determinations associated with resource scheduling, load balancing, link adaptation, mobility decisions, and similar determinations, resulting in efficient use of network resources.

As indicated above, FIG. 5 is provided as an example. Other examples may differ from what is described with respect to FIG. 5.

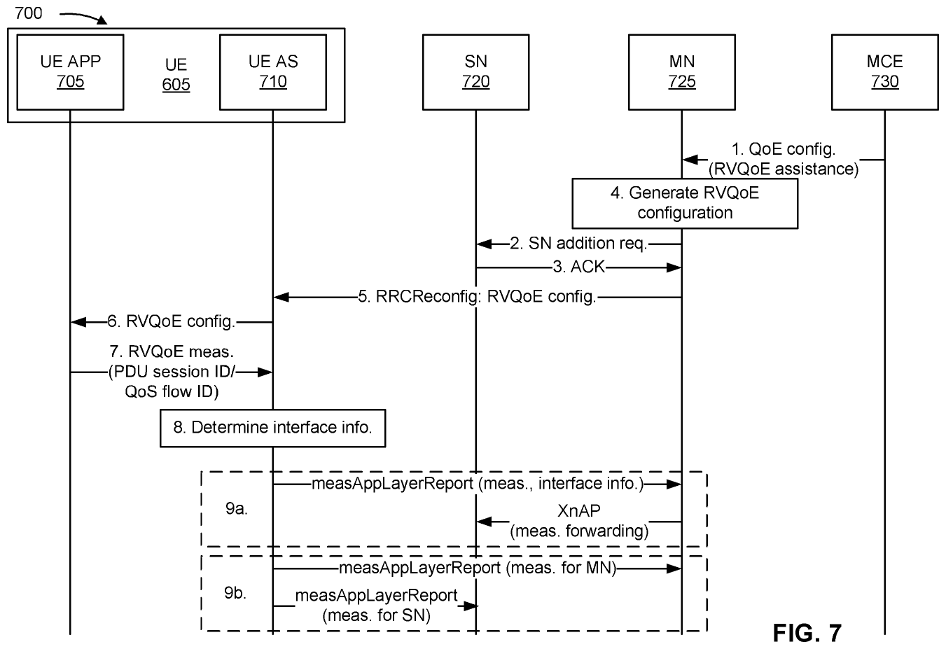

FIG. 6 is a diagram illustrating an example 600 associated with configuration of QoE and/or RVQoE measurements for a dual connectivity mode, in accordance with the present disclosure. As shown in FIG. 6, a UE 605 may communicate with an MN 610 and an SN 615. For example, the UE 605 may be operating in a dual connectivity mode (e.g., NRDC or other dual connectivity mode) in which the UE 605 is connected to, or intends to connect to, both the MN 610 and the SN 615, and thus, in some aspects, the UE 605 may communicate with each of the MN 610 and the SN 615 via one or more DRBs, SRBs, or the like. The UE 605 may correspond to any of the UEs described herein, such as the UE 120. Moreover, the MN 610 and the SN 715 may correspond to any of the network entities described herein, such as a base station 110, a CU 310, a DU 330, an RU 340, a RAN 520, or similar network entity. Although for ease of discussion the aspects shown in FIG. 6 are described in connection with RVQoE configurations, measurements, and reporting, in some other aspects, the UE 605 may be configured to measure and report QoE metrics in a substantially similar manner, as described in more detail in connection with FIGS. 7-10.

As shown by reference numbers 620 and 625, the UE 605 may receive, from the MN 610 and/or the SN 615, respectively, one or more RVQoE configurations. In some aspects, the one or more RVQoE configurations may configure one more RVQoE measurements by the UE 605, and, in some aspects, a periodicity to perform the one or more RVQoE measurements. In some aspects, the configured RVQoE measurements may be associated with a QoE metric for which the UE 605 is capable of measuring. In that regard, in some aspects, the UE 605 may transmit, to the MN 610 and/or the SN 615, capability information indicating which QoE metrics the UE 605 is capable of measuring. For example, the capability information may be transmitted in a similar manner as described in connection with step 0 of FIG. 5. In some aspects, the configured RVQoE measurements may be associated with one or more of a buffer level metric, an average throughput metric, a playout delay metric, or a play list metric.

A buffer level metric may indicate a list of buffer occupancy level measurements associated with one or more applications during playout at normal speed. The level of the buffer may be indicated in milliseconds, which may indicate the playout duration for which media data of all active media components is available starting from a current playout time. In some aspects, a buffer level metric may also include a time of the measurement of the buffer level. An average throughput metric may indicate an average throughput as observed by a client during a measurement interval. A playout delay metric may indicate a time in milliseconds from a fetch of a first media segment or sub-segment and a time at which media is retrieved from a client buffer. And a play list metric may indicate a list of playback periods, which may be time intervals between a user action and an end of playback or a failure that stops playback, whichever occurs first.

In some aspects, the UE 605 may receive one or more RVQoE configurations from only one of the MN 610 or the SN 615, while, in some other aspects, the UE 605 may receive one or more RVQoE configurations from both the MN 610 (as shown by reference number 620) and the SN 615 (as shown by reference number 625). For example, in some aspects, the UE 605 may receive, from the MN 610, a common RVQoE configuration. A common RVQoE configuration may be an RVQoE configuration that is applicable to both the MN connectivity and the SN connectivity, and which does not otherwise include an MN-specific component or an SN-specific component. Aspects of the common RVQoE configuration are described in more detail in connection with FIG. 7.

In some other aspects, the one or more RVQoE configurations received by the UE 605 may include an MN-specific RVQoE configuration and an SN-specific RVQoE configuration. That is, the one or more RVQoE configurations may include a configuration of RVQoE measurements and/or metrics requested by the MN 610 (e.g., the MN-specific RVQoE configuration) as well as a configuration of RVQoE measurements and/or metrics requested by the SN 615 (e.g., the SN-specific RVQoE configuration). In such aspects, the MN 610 may provide information to the SN 615 that is used by the SN 615 to generate the SN-specific RVQoE configuration, which is sometimes referred to herein as RVQoE assistance information. For example, in some aspects, the SN-specific RVQoE configuration may be based at least in part on a list of available RVQoE configurations provided by the MN 610 to the SN 615. Further details regarding the RVQoE assistance information are described in connection with FIGS. 7-10.

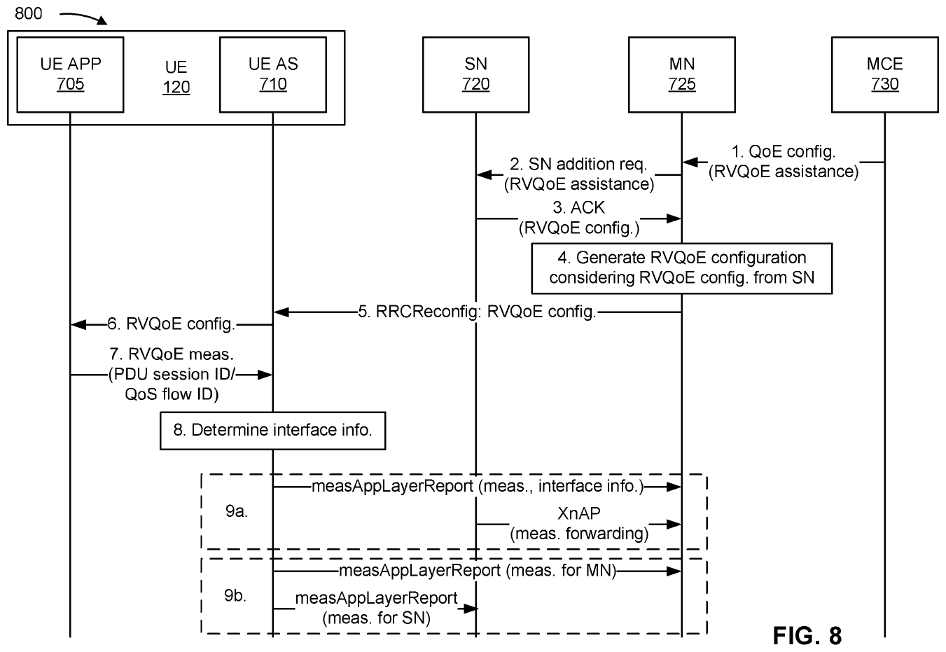

In some aspects, the MN-specific RVQoE configuration and the SN-specific RVQoE configuration may be received by the UE 605 from a single RAN node (e.g., from one of the MN 610 or the SN 615) and/or in a single message (e.g., one of the message indicated by reference number 620 or the message indicated by reference number 625), while, in some other aspects, the MN-specific RVQoE configuration and the SN-specific RVQoE configuration may be received by the UE 605 from multiple RAN nodes (e.g., from both the MN 610 and the SN 615) and/or in multiple messages (e.g., in both the message indicated by reference number 620 and the message indicated by reference number 625). For example, in some aspects the SN 615 may transmit the SN-specific RVQoE configuration to the MN 610, and the MN 610 may thus transmit the MN-specific RVQoE configuration and the SN-specific RVQoE configuration to the UE 605 via the message indicated by reference number 620 (e.g., in some aspects, the MN-specific RVQoE configuration and the SN-specific RVQoE configuration may be received from the MN 610). In such aspects, the SN 615 may transmit SN-specific RVQoE configuration information to the MN 610 via an Xn application (XnAP) protocol information element (IE), and the MN 610 may generate the one or more RVQoE configurations based at least in part on the SN-specific RVQoE configuration information contained in the XnAP protocol IE. Alternatively, the SN 615 may transmit the SN-specific RVQoE configuration to the MN 610 via a cell group (CG) container, and the MN 610 may forward the CG container (including the SN-specific RVQoE configuration) to the UE 605 via the message indicated by reference number 620. Aspects in which the MN-specific RVQoE configuration and the SN-specific RVQoE configuration may be received from the MN 610 are described in more detail in connection with FIGS. 8-10.

In some other aspects, the SN 615 may transmit the SN-specific RVQoE configuration directly to the UE 605 via the message indicated by reference number 625, and the MN 610 may transmit the MN-specific RVQoE configuration to the UE 605 via the message indicated by reference number 620 (e.g., in some aspects, the MN-specific RVQoE configuration is received from the MN 610 and the SN-specific RVQoE configuration is received from the SN 615). For example, the SN 615 may transmit the SN-specific RVQoE configuration to the UE 605 via an SRB3, or the like.

Additionally, or alternatively, the MN 610 may generate the MN-specific RVQoE configuration based at least in part on RVQoE assistance received from the UE 605, and/or the SN 615 may generate the SN-specific RVQoE configuration based at least in part on RVQoE assistance received from the UE 605. For example, the UE 605 may transmit, to one or both of the MN 610 and the SN 615, an indication that a first set of one or more RVQoE configurations are associated with the MN 610 and that a second set of one or more RVQoE configurations are associated with the SN 615. In such aspects, the MN-specific RVQoE configuration and/or the SN-specific RVQoE configuration may be based at least in part on the UE providing the indication that the first set of one or more RVQoE configurations are associated with the MN and that the second set of one or more RVQoE configurations are associated with the SN. Aspects in which the MN-specific RVQoE configuration and the SN-specific RVQoE configuration may be received separately from the MN 610 and the SN 615, respectively, are described in more detail in connection with FIGS. 8-10.

As shown by reference number 630, in some aspects, the UE 605 may collect at least one RVQoE metric based at least in part on the one or more RVQoE configurations received from the MN 610 and/or the SN 615. For example, and as described above, the UE 605 may collect one or more of a buffer level metric, an average throughput metric, a playout delay metric, a play list metric, or another RVQoE metric. Moreover, in some aspects, the UE 605 may determine whether each RVQoE configuration is associated with one of MN connectivity or SN connectivity. Put another way, the UE 605 may determine whether an application associated with each collected RVQoE metric is operating over the MN interface or the SN interface. Aspects of determining whether each RVQoE configuration is associated with one of MN connectivity or SN connectivity will be described in more detail in connection with FIGS. 7-10.

As shown by reference numbers 635 and 640, in some aspects, the UE 605 may transmit, to at least one of the MN 610 or the SN 615, at least one RVQoE measurement report based at least in part on the one or more RVQoE configurations. In some aspects, the UE 605 may transmit one or more RVQoE measurement reports to only one of the MN 610 or the SN 615, while, in some other aspects, the UE 605 may transmit one or more RVQoE measurement reports to the MN 610 (as shown by reference number 635) and one or more RVQoE measurement reports to the SN 615 (as shown by reference number 640). For example, the UE 605 may transmit RVQoE measurement reports associated with applications operating on the MN interface to the MN 610 (as shown by reference number 635), and the UE 605 may transmit RVQoE measurement reports associated with applications operating on the SN interface to the SN 615 (as shown by reference number 640).

In aspects in which the one or more RVQoE measurement reports are transmitted to only one of the MN 610 or the SN 615, the UE 605 may provide interface information such that the one of the MN 610 or the SN 615 may forward applicable RVQoE measurement reports to the other one of the MN 610 or the SN 615. For example, the at least one RVQoE measurement report may include a first RVQoE measurement report associated with the MN 610 and a second RVQoE measurement report associated with the SN 615. In some aspects, the UE 605 may transmit, to the MN 610, both the first RVQoE measurement report and the second RVQoE measurement report, and may additionally transmit at least one of interface information or bearer information indicating that the first RVQoE measurement report is associated with the MN 610 and/or that the second RVQoE measurement report is associated with the SN 615. The at least one interface information or bearer information may be any information that may be used by the MN 610 to map measurement reports to the MN connectivity and/or the SN connectivity. For example, the at least one of interface information or bearer information may include at least one of an indication of one of MN connectivity or SN connectivity associated with each RVQoE measurement report, an indication of one of an MCG bearer or an SCG bearer associated with each RVQoE measurement report, an indication of one of an MCG leg of a split bearer or an SCG leg of a split bearer associated with each RVQoE measurement report, a bearer identifier associated with each RVQoE measurement report, a packet data unit (PDU) session identifier associated with each RVQoE measurement report, or a quality of service (QoS) flow identifier associated with each RVQoE measurement report. In this way, the MN 610 may determine which RVQoE measurement reports apply to SN connectivity, and thus forward the applicable RVQoE measurement reports to the SN 615. Aspects of mapping RVQoE measurement reports to each of the MN 610 and SN 615 and forwarding applicable measurement reports to the SN 615 are described in more detail in connection with steps 7, 8, and 9a of FIGS. 7-10.

In some other aspects, the UE 605 may determine which RVQoE configurations are applicable to each of the MN 610 and the SN 615 (as described in connection with reference number 630), and thus may directly transmit RVQoE measurement reports associated with MN connectivity to the MN 610 and RVQoE measurement reports associated with SN connectivity to the SN 615. Put another way, in some aspects, at least one RVQoE measurement report may include a first RVQoE measurement report associated with the MN 610 and a second RVQoE measurement report associated with the SN 615, and the UE 605 may transmit the first RVQoE measurement report to the MN 610 and the second RVQoE measurement report to the SN 615. Aspects of mapping RVQoE measurement reports to each of the MN 610 and SN 615 and transmitting applicable measurement reports to the MN 610 and the SN 615 are described in more detail in connection with steps 7, 8, and 9b of FIGS. 7-10.

In some aspects, one or more of the RAN nodes (e.g., the MN 610 or the SN 615), the RVQoE configurations, the applications operating at the UE 605, or the RVQoE measurement reports and/or metrics may be associated with an RRC identifier in order to map the RVQoE measurement reports to a corresponding connectivity or the like. For example, in some aspects, the one or more RVQoE configurations may include an MN-specific RVQoE configuration and an SN-specific RVQoE configuration, as described. In such aspects, the MN-specific RVQoE configuration may be associated with a first set of one or more RRC identifiers, and the SN-specific RVQoE configuration may be associated with a second set of one or more RRC identifiers. In some aspects, the RRC identifiers associated with the MN 610 and/or the MN-specific RVQoE configuration may not overlap with the RRC identifiers associated with the SN 615 and/or the SN-specific RVQoE configuration, while, in some other aspects, one or more RRC identifiers associated with the MN 610 and/or the MN-specific RVQoE configuration may overlap with one or more RRC identifiers associated with the SN 615 and/or the SN-specific RVQoE configuration.

For example, in some aspects, the first set of one or more RRC identifiers (e.g., the set of RRC identifiers associated with the MN-specific RVQoE configuration) may include a first RRC identifier, and the second set of one or more RRC identifiers (e.g., the set of RRC identifiers associated with the SN-specific RVQoE configuration) may include a second RRC identifier different than the first RRC identifier. In such aspects, the UE 605 may report RVQoE measurements to each of the MN 610 and the SN 615 only if the corresponding MN/SN-specific RVQoE configuration indicates an RRC identifier and that RRC identifier is associated with an application operating on the corresponding MN/SN interface. Put another way, in some aspects the UE 605 may report a first RVQoE measurement report associated with the first RRC identifier to the MN based at least in part on an application associated with the first RRC identifier being associated with MN connectivity, and/or the UE 605 may report a second RVQoE measurement report associated with the second RRC identifier to the SN based at least in part on an application associated with the second RRC identifier being associated with SN connectivity.

In some aspects, when a MN/SN-specific RVQoE configuration indicates an RRC identifier but that RRC identifier is associated with an application operating on another interface, the UE 605 may either drop reporting of the RVQoE measurement report, or else may report the RVQoE measurement report to the other RAN node (e.g., the other of the MN 610 or the SN 615). Put another way, in some aspects the UE 605 may drop reporting of a first RVQoE measurement report associated with the second RRC identifier (e.g., an RRC identifier indicated by the SN-specific RVQoE configuration) based at least in part on an application associated with the second RRC identifier being associated with MN connectivity, or else the UE 605 may report the first RVQoE measurement report associated with the second RRC identifier to the MN 610 based at least in part on the application associated with the second RRC identifier being associated with the MN connectivity. In aspects in which the UE 605 reports the RVQoE measurement report to the other RAN node, the UE 605 may indicate that the RVQoE measurement report was configured by a different RAN node. Returning to the above example, if the UE 605 reports the first RVQoE measurement report associated with the second RRC identifier to the MN 610 based at least in part on the application associated with the second RRC identifier being associated with the MN connectivity, the UE 605 may also indicate that the first RVQoE measurement report was configured by the SN 615 (e.g., was indicated by the SN-specific RVQoE configuration).

Alternatively, and as described, in some aspects, one or more RRC identifiers associated with the MN 610 and/or the MN-specific RVQoE configuration may overlap with one or more RRC identifiers associated with the SN 615 and/or the SN-specific RVQoE configuration. For example, the first set of one or more RRC identifiers (e.g., the set of RRC identifiers associated with the MN-specific RVQoE configuration) and the second set of one or more RRC identifiers (e.g., the set of identifiers associated with the SN-specific RVQoE configuration) may both include a first RRC identifier. In such aspects, the UE 605 may only use the RVQoE configuration from a predetermined RAN node (e.g., the MN 610), or may only use a latest received RVQoE configuration, or may determine which RVQoE configuration to use for each RVQoE metric based at least in part a connectivity of the application associated with the RVQoE metric, or the like.

More particularly, in some aspects, when the first set of one or more RRC identifiers and the second set of one or more RRC identifiers both include a first RRC identifier, the UE 605 may transmit, from an AS layer of the UE 605 to an APP layer of the UE 605, the MN-specific RVQoE configuration (e.g., may transmit the predetermined node's configuration, which, in this example, is the MN 610). Alternatively, when the first set of one or more RRC identifiers and the second set of one or more RRC identifiers both include a first RRC identifier, the UE 605 may transmit, from an AS layer of the UE 605 to an APP layer of the UE 605, a latest-received RVQoE configuration of the MN-specific RVQoE configuration or the SN-specific RVQoE configuration. Alternatively, when the first set of one or more RRC identifiers and the second set of one or more RRC identifiers both include a first RRC identifier, the UE 605 may transmit, from an AS layer of the UE 605 to an APP layer of the UE 605, the MN-specific RVQoE configuration and the SN-specific RVQoE configuration, and the UE 605 (e.g., the APP layer of the UE 605) may determine whether to use the MN-specific RVQoE configuration and the SN-specific RVQoE configuration based at least in part on a connectivity of an application associated with the first RRC identifier.

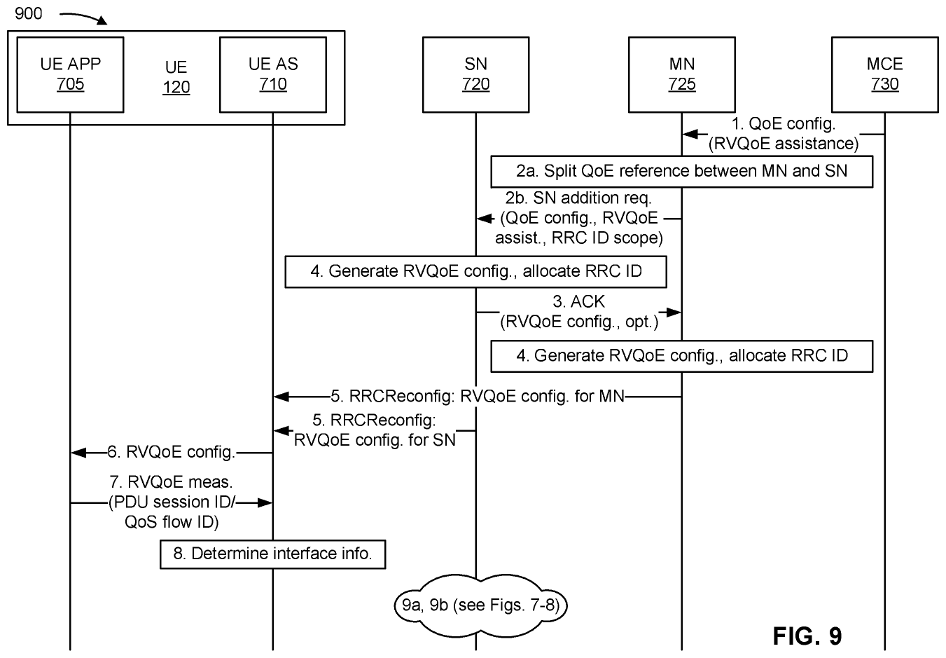

In such aspects, the UE 605 may report only RVQoE measurement reports to each of the MN 610 and the SN 615 that are associated with the corresponding connectivity. For example, in some aspects the first set of one or more RRC identifiers and the second set of one or more RRC identifiers may both include a first RRC identifier and a second RRC identifier. In such aspects, the UE 605 may report a first RVQoE measurement report associated with first RRC identifier to the MN 610 based at least in part on an application associated with the first RRC identifier being associated with MN connectivity, and the UE 605 may report a second RVQoE measurement report associated with the second RRC identifier to the SN 615 based at least in part on an application associated with the second RRC identifier being associated with SN connectivity. Aspects of RRC identifier handling are described in more detail in connection with FIG. 9.

Based at least in part on UE 605 that is operating in a dual connectivity mode receiving RVQoE configurations and reporting RVQoE measurement reports, the UE 605, the MN 610, and/or the SN 615 may conserve computing, power, network, and/or communication resources that may have otherwise been consumed parsing, decoding, and forwarding QoE measurement reports when needed by one of the MN 610 or the SN 615. For example, based at least in part on UE 605 receiving RVQoE configurations and reporting RVQoE measurement reports to the MN 610 and/or the SN 615, the UE 605, the MN 610, and/or the SN 615 may efficiently and effectively utilize certain RVQoE measurements for purposes of QoE aware scheduling, QoE aware load balancing, link adaptation, mobility decision evaluation after a handover, or the like, which may conserve computing, power, network, and/or communication resources that may have otherwise been consumed to parse, decode, and forward QoE measurements at the RAN nodes.

As indicated above, FIG. 6 is provided as an example. Other examples may differ from what is described with respect to FIG. 6.

FIG. 7 is a diagram illustrating another example 700 associated with configuration of QoE and/or RVQoE measurements for a dual connectivity mode, in accordance with the present disclosure. As shown in FIG. 7, a UE APP layer or entity (e.g., UE APP 705) may communicate with a UE AS layer or entity (e.g., UE AS 710), with the UE APP 705 and the UE AS 710 being associated with the same UE (e.g., UE 605). Moreover, the UE 605 may be operating in a dual connectivity mode (e.g., an NRDC mode, or the like) and thus communicate over a wireless network (e.g., wireless network 100) with an SN 720 (e.g., a base station 110, a CU 310, a DU 330, and RU 340, SN 615, or a similar network entity) and an MN 725 (e.g., a base station 110, a CU 310, a DU 330, and RU 340, MN 610, or a similar network entity). In some aspects, the SN 720 and/or the MN 725 may correspond to a RAN entity (e.g., an NG-RAN entity), such as the RAN entity 520 described in connection with FIG. 5. The UE 605, the SN 720, and/or the MN 725 may further communicate with components of the core network, such as an MCE entity (e.g., MCE 730).

As shown as step 1 in FIG. 7, in some aspects, the MCE 730 may configure the MN 725 with a QoE configuration. The QoE configuration may include a number of different QoE measurements and/or metrics for the UE 605 to measure. In some aspects, collecting QoE measurements and/or metrics may be referred to as QoE measurement collection (QMC), and thus, in some aspects, the configuration shown as step 1 in FIG. 7 and/or related parameters and information may be referred to as QMC information. As described in connection with FIG. 5, if the UE 605 measures such QoE measurements and/or metrics without additional configuration (e.g., without receiving the one or more RVQoE configurations), the QoE measurements and/or metrics may be transparent to the MN 725 and/or the SN 720 because they may be reported in zipped XML files or the like. In this regard, the MN 725 and/or the SN 720 may additionally configure the UE 605 with one or more RVQoE configurations such that the UE 605 may provide RVQoE measurements and/or metrics to the MN 725 and/or the SN 720. In that regard, the QoE configuration shown at step 1 may include RVQoE assistance information. This information may indicate certain parameters to enable the MN 725 and/or the SN 720 to generate one or more RVQoE configurations, such as a list of available QoE metrics that may be performed at the UE 605.

For example, in some aspects, a RAN entity (e.g., the MN 725 and/or the SN 720) may be able to configure RVQoE measurements for a given service type only if the application layer QoE for the same service type is already configured via the QoE configuration from the MCE 730, or the like. Additionally, or alternatively, a RAN entity (e.g., the MN 725 and/or the SN 720) may only be able to configure RVQoE measurements for a metric specified by a wireless communication standard, such as metrics specified by the 3GPP Technical Specification Group Service and System Aspects (SA) working group 4 (WG4) (e.g., SA4), and such metrics may be indicated by the RVQoE assistance information or otherwise indicated to the MN 725 and/or the SN 720. Additionally, or alternatively, a RAN entity (e.g., the MN 725 and/or the SN 720) may only be able to configure RVQoE measurements that the UE 605 is capable of performing, and thus, in such aspects, the UE 605 may transmit capability information to one or both of the MN 725 or the SN 720, such as was described in connection with step 0 in connection with FIG. 5, and the one or more RVQoE configurations may be based at least in part on the capability information.

In the example shown in FIG. 7, the MN 725 may configure the UE 605 itself (e.g., without input from the SN 720 and/or without receiving configuration information from the SN 720). Thus, as shown as step 4 in FIG. 7, the MN 725 may generate one or more QoE configurations (e.g., a configuration of QoE measurements that, in some aspects, may be transparent to the RAN nodes) and/or one or more RVQoE configurations (e.g., a configuration of RVQoE measurements), which may be based at least in part on the QMC information and/or the RVQoE assistance information received from the MCE 730. As shown as step 2 in FIG. 7, the MN 725 may transmit, to the SN 720, an SN addition request, which may be used to add the SN 720 as a secondary node for purposes of dual connectivity (if the SN 720 is not already connected to the UE 605). In some aspects, the SN addition request may include certain configuration information in order to add the SN 720 as a secondary node for purposes of dual connectivity, such as RRC configuration information, radio bearer configuration information, UE capability information, security information such as for purposes of enabling the SRB3, or the like. Moreover, in aspects in which a QMC activation IE has been previously received for the UE 605, the QMC activation IE may be included in the SN addition request, and, if the QMC activation IE is included in the SN addition request, the SN 720 may, if supported, initiate the requested QMC function. In some aspects, the SN 720 may provide an SN addition request acknowledgement (ACK) message, as shown as step 3, which may include information about radio resources and bearers, RRC configuration information, or the like to be transmitted to the UE 605. Although in the example shown in FIG. 7 step 4 is shown as being performed prior to steps 2 and 3, in some other aspects, steps 2 and 3 may be performed prior to step 4 without departing from the scope of the disclosure.

Moreover, in some aspects, as part of the SN addition request or else using additional signaling, the MN 725 may signal to the SN 720 a request for the SN 720 to initiate a QoE measurement procedure (sometimes referred to as a QMC session) for the UE 605. More particularly, the MN 725 may initiate a QMC start procedure by transmitting a QMC start message to the SN 720 for the specific UE 605. In some aspects, upon receiving the QMC start message, the SN 720 may initiate the requested QMC session. Relatedly, in some aspects, the MN 725 may use a deactivate QMC procedure to request the SN 720 to stop the QMC session for the indicated QoE reference. More particularly, the MN 725 may initiate a deactivate QMC procedure by transmitting a deactivate QMC message to the SN 720 for the specific UE 605. In some aspects, upon receiving the deactivate QMC message, the SN 720 may stop the QMC session for the indicated QoE reference. In some aspects, the deactivate QMC message may be part of an SN modification or release procedure.

Additionally, or alternatively, in some aspects a management-based QoE activation procedure may be utilized, such as the procedure described above in connection with step 2b of FIG. 5. In such aspects, an OAM (e.g., OAM 510) or similar network function may activate the QoE measurement procedure by forwarding the QoE measurement configuration directly to a RAN (e.g., the MN 725 and/or the SN 720). In some aspects, when a management-based QoE activation procedure is implemented, the SN 720 may send a cell traffic QMC message to the MN 725. The cell traffic QMC message may include certain QMC information such as one or more QoE references, one or more RRC identifiers, privacy information, or the like. In some aspects, upon receipt of the cell traffic QMC message, the MN 725 may send a cell traffic QMC message (including the one or more QoE references, one or more RRC identifiers, privacy information, or the like) to the core network associated with the UE 605. In such aspects, the core network may forward certain information, such as the one or more QoE references and the UE 605 identify, to the MCE 730.

Additionally, or alternatively, in some aspects, the SN 720 may utilize a cell traffic QMC procedure (sometimes referred to as a cell traffic trace procedure) in order to provide certain information (such as one or more QoE references, one or more RRC identifiers, privacy information, or the like) to the MN 725. For example, the SN 720 may transmit a cell traffic QMC message to the MN 725 including the relevant information. In some aspects, if a privacy indicator IE is included in the cell traffic QMC message, the MN 725 may take the information into account for purposes of anonymization of QMC data.

As shown as step 5, the MN 725 may transmit, to the UE 605 (more particularly, to the UE AS 710), an RRC reconfiguration message. Although in FIG. 7 the RRC reconfiguration message is shown as being provided over MN connectivity, in some other aspects, the RRC reconfiguration message may be transmitted over SN connectivity and/or using a split bearer. In aspects in which the RRC reconfiguration information is transmitted over SN connectivity, the MN 725 may provide the RRC message to the SN 720 over XnAP as a container for transmission over the SN connectivity, and/or the MN 725 may provide the generated QoE and/or RVQoE configuration to the SN 720 over XnAP as a container for incorporation into an RRC message to be sent over SN connectivity. In some aspects, the RRC reconfiguration message may include SN 720 RRC configuration information in order for the UE 605 to connect to the SN 720. Additionally, or alternatively, the RRC reconfiguration message may include the one or more QoE and/or RVQoE configurations generated by the MN 725 at step 4. As shown as step 6, the UE AS 710 may transmit the one or more QoE and/or RVQoE configurations to the UE APP 705. The UE APP 705 may then perform one or more measurements based at least in part on the QoE and/or RVQoE configuration (e.g., the UE APP 705 may collect one or more QoE metrics and/or one or more RVQoE metrics). For example, the UE APP 705 may perform one or more of a buffer occupancy level measurement during playout at normal speed (which may include a time of measurement of the buffer level), an average throughput measurement, a playout delay measurement, a play list measurement, or the like, as described in connection with FIG. 6.

As shown as step 7, the UE APP 705 may report the one or more QoE and/or RVQoE measurements and/or metrics to the UE AS 710 via a measurement report or the like. In some aspects, the UE APP 705 may also indicate certain identifiers or the like used to determine an interface and/or connectivity (e.g., MN connectivity or SN connectivity) associated with each QoE and/or RVQoE measurement and/or metric. For example, the UE APP 705 may indicate a PDU session identifier associated with each QoE and/or RVQoE measurement and/or metric, a QoS flow identifier associated with each QoE and/or RVQoE measurement and/or metric, or the like. Then, as shown as step 8, the UE AS 710 may determine interface information for and/or connectivity (e.g., MN connectivity or SN connectivity) associated with each QoE and/or RVQoE measurement and/or metric. For example, the UE AS 710 may determine that a first set of one or more QoE and/or RVQoE measurements and/or metrics are associated with the MN connectivity and/or MN interface, and that a second set of one or more QoE and/or RVQoE measurements and/or metrics are associated with the SN connectivity and/or SN interface. In some aspects, the UE AS 710 may determine an associated interface and/or connectivity associated with each QoE and/or RVQoE metric based at least in part on information provided by the UE APP 705. For example, the UE AS 710 may map PDU session identifiers and/or QoS flow identifiers provided by the UE APP 705 to each connectivity and/or interface.

As shown as steps 9a and 9b in FIG. 7, the UE 605 (more particularly, the UE AS 710) may report the one or more QoE and/or RVQoE measurements and/or metrics to one or both of the MN 725 or the SN 720. First, in the alternative shown as step 9a, the UE AS 710 may transmit the one the one or more QoE and/or RVQoE measurements and/or metrics to the MN 725. For example, in some aspects, a report used to transmit the one the one or more QoE and/or RVQoE measurements and/or metrics to the MN 725 may be referred to as a meaAppLayerReport. The measurement report (e.g., the meaAppLayerReport) may include one or more QoE and/or RVQoE measurements and/or metrics as well as interface information in order for the MN 725 to determine which of the one or more QoE and/or RVQoE measurements and/or metrics are associated with the MN 725 and which of the one or more QoE and/or RVQoE measurements and/or metrics are associated with the SN 720. The interface information may be any information indicating which QoE and/or RVQoE measurements and/or metrics are associated with each of the MN 725 or the SN 720. For example, the interface information may include an indication whether each QoE and/or RVQoE measurement and/or metric is associated with MN connectivity (and thus is associated with the MN 725) or SN connectivity (and thus is associated with the SN 720). Additionally, or alternatively, the interface information may include an indication whether each QoE and/or RVQoE measurement and/or metric is associated with an MCG bearer (and thus is associated with the MN 725) or an SCG bearer (and thus is associated with the SN 720). Additionally, or alternatively, the interface information may include an indication whether each QoE and/or RVQoE measurement and/or metric is associated with an MCG leg of a split bearer (and thus is associated with the MN 725) or an SCG leg of a split bearer (and thus is associated with the SN 720). Additionally, or alternatively, the interface information may include an indication of a bearer identifier associated with each QoE and/or RVQoE measurement and/or metric, which may then be mapped to one of the MN 725 or the SN 720 by the MN 725. Additionally, or alternatively, the interface information may include an indication of a PDU session identifier associated with each QoE and/or RVQoE measurement and/or metric, which may then be mapped to one of the MN 725 or the SN 720 by the MN 725. Additionally, or alternatively, the interface information may include an indication of a QoS flow identifier associated with each QoE and/or RVQoE measurement and/or metric, which may then be mapped to one of the MN 725 or the SN 720 by the MN 725. Based at least in part on the interface information transmitted by the UE AS 710, the MN 725 may then determine which of the QoE and/or RVQoE measurements and/or metrics, if any, are associated with the SN 720 (e.g., which measurement and/or metric is attributable to SN connectivity), and forward the measurement and/or metric to the SN 720. More particularly, in some aspects, the MN 725 may forward the applicable QoE and/or RVQoE measurements and/or metrics to the SN 720 using an XnAP protocol, or the like.

In the alternative shown as step 9b in FIG. 7, the UE AS 710 may transmit a first set of one or more QoE and/or RVQoE measurements and/or metrics to the MN 725 and a second set of one or more QoE and/or RVQoE measurements and/or metrics to the SN 720. In such aspects, based at least in part on determining the interface information associated with each QoE and/or RVQoE measurement or metric, as described above in connection with step 8, the UE AS 710 may directly forward the QoE and/or RVQoE measurements and/or metrics associated with the MN connectivity to the MN 725, and may directly forward the QoE and/or RVQoE measurements and/or metrics associated with the SN connectivity to the SN 720. The UE AS 710 may do so using a first meaAppLayerReport that is transmitted to the MN 725, and a second meaAppLayerReport that is transmitted to the SN 720.

In some aspects, the UE AS 710 may report QoE and/or RVQoE measurements to the SN 720 using an SCG bearer. For example, in some aspects, the UE AS 710 may report QoE and/or RVQoE measurements to the SN 720 using an SRB5 bearer. In aspects in which QoE measurements are reported to the SN 720 using the SRB5 bearer or the like, the SN 720 may froward the QoE measurements to the MCE 730 directly, or else the SN 720 may forward a QoE reporting RRC message to the MN 725 using an XnAP message (sometimes referred to as an RRC transfer message), and the MN 725 may then forward the QoE measurements to the MCE 730.

Additionally, or alternatively, in some aspects, the UE AS 710 may report the QoE and/or RVQoE measurements using a split bearer (which may be associated with SRB4 and/or SRB5). For example, in some aspects, the MN 725 or the SN 720 may transmit a configuration of a split bearer to the UE 605 to be used for QoE and/or RVQoE reporting. In some aspects, the configuration may indicate which leg (e.g., MCG leg and/or SCG leg) should be used for QoE and/or RVQoE reporting. Additionally, or alternatively, the configuration may indicate which measurements (e.g., which QoE and/or RVQoE configurations) should be reported using the split bearer.

In some aspects, a RAN node (e.g., the MN 725 and/or the SN 720) may initiate a pause (or, alternatively, a resumption) of QoE and/or RVQoE reporting based at least in part on the RAN node being overloaded with QoE and/or RVQoE reports. For example, if the MN 725 and/or the SN 720 becomes overloaded with QoE and/or RVQoE reports, the MN 725 and/or the SN 720 may transmit a message to the UE 605 to pause QoE and/or RVQoE collection and/or reporting, and may later transmit a message to the UE 605 to resume QoE and/or RVQoE collection and/or reporting once the MN 725 and/or the SN 720 is no longer overloaded. In some aspects, one of the RAN nodes may transmit such a pause or resumption indication to another of the RAN nodes. For example, one of the SN 720 or the MN 725 may transmit a message to the other one of the SN 720 or the MN 725 indicating that QoE reporting should be paused or resumed. The other one of the SN 720 or the MN 725 (e.g., the RAN node that received the indication) may then transmit the pause or resumption request to the UE 605 indicating that the UE 605 should pause or resume the QoE and/or RVQoE measurements indicated by the one of the SN 720 or the MN 725 (e.g., the RAN node that initiated the indication). Additionally, or alternatively, the other one of the SN 720 or the MN 725 (e.g., the RAN node that received the indication) may reconfigure bearers associated with QoE and/or RVQoE configurations indicated by the pause or resumption request. For example, in aspects in which the SN 720 initiates a pause request for a certain QoE and/or RVQoE measurement, the MN 725 may reconfigure bearers associated with those QoE and/or RVQoE measurement to an MCG bearer such that the UE 605 will begin to forward the certain QoE and/or RVQoE measurement to the MN 725.

In this regard, aspects of the configuration of QoE and/or RVQoE measurements for a dual connectivity mode shown in FIG. 7 enable the configuration and/or use of QoE and/or RVQoE measurements by one or more RAN entities associated with a UE operating in a dual connectivity mode.

As indicated above, FIG. 7 is provided as an example. Other examples may differ from what is described with respect to FIG. 7.

FIG. 8 is a diagram illustrating another example 800 associated with configuration of QoE and/or RVQoE measurements for a dual connectivity mode, in accordance with the present disclosure.

In the example shown in FIG. 8, the MN 725 may generate one or more QoE and/or RVQoE configurations that include one or more QoE and/or RVQoE configurations associated with the SN 720. Put another way, rather than generating a common QoE and/or RVQoE configuration, as described in connection with FIG. 7, in this aspect the MN 725 may generate one or more QoE and/or RVQoE configurations that include an MN component (e.g., an MN-specific QoE and/or RVQoE configuration), and an SN component (e.g., an SN-specific QoE and/or RVQoE configuration). More particularly, as shown as step 1, the MN 725 may receive, from the MCE 730, QoE configuration information (e.g., QMC information), including the RVQoE assistance information, as described above. In this aspect, the MN 725 may provide the RVQoE assistance information to the SN 720 as part of the SN addition request, as shown as step 2. The MN 725 may provide the RVQoE assistance information to the SN 720 using an XnAP protocol or the like. The SN addition request may include additional information used to add the SN 720 as a secondary node for purposes of dual connectivity (e.g., RRC configuration information, radio bearer configuration information, UE capability information, security information such as for purposes of enabling the SRB3, or the like), and/or may include the QMC activation IE, as described above in connection with FIG. 7.

As shown as step 3, the SN 720 may provide an SN-specific QoE and/or RVQoE configuration to the MN 725, which may be transmitted as part of an SN addition request ACK message. In some aspects, the SN-specific QoE and/or RVQoE configuration may include a configuration of QoE and/or RVQoE measurements and/or metrics that the SN 720 is requesting from the UE 605, and/or a periodicity of the requested QoE and/or RVQoE measurements and/or metrics. The ACK message may include additional information as described above in connection with FIG. 7, such as information about radio resources and bearers, and/or RRC configuration information to be transmitted to the UE 605. Moreover, in some aspects, the SN 720 may transmit the SN-specific QoE and/or RVQoE configuration information to the MN 725 using an XnAP IE or the like, while, in some other aspects, the SN 720 may transmit the SN-specific QoE and/or RVQoE configuration information to the MN 725 in a CG container.

As shown as step 4, the MN 725 may generate one or more QoE and/or RVQoE configurations considering the SN-specific QoE and/or RVQoE configuration information. For example, in aspects in which the SN 720 transmitted the SN-specific QoE and/or RVQoE configuration information to the MN 725 using an XnAP IE or the like (and thus the SN-specific QoE and/or RVQoE configuration information may be visible to the MN 725), the MN 725 may generate the one or more QoE and/or RVQoE configurations considering the SN-specific QoE and/or RVQoE configuration information, such as by generating an QoE and/or RVQoE configuration that configures QoE and/or RVQoE measurements and/or metrics and a corresponding periodicity that the SN 720 is requesting from the UE 605, in addition to QoE and/or RVQoE measurements and/or metrics and/or a corresponding periodicity that the MN 725 is requesting from the UE 605. In aspects in which the SN 720 transmitted the SN-specific QoE and/or RVQoE configuration information to the MN 725 using a CG container or the like (and thus the SN-specific QoE and/or RVQoE configuration information may be transparent to the MN 725), the MN 725 may forward the CG container to UE 605, and thus, at step 4, the MN 725 may generate one or more QoE and/or RVQoE configurations that includes QoE and/or RVQoE measurements and/or metrics and/or a corresponding periodicity that the MN 725 is requesting from the UE 605.

As shown as step 5, the MN 725 may transmit, to the UE 605 (more particularly, to the UE AS 710), an RRC reconfiguration message. As described above in connection with FIG. 7, in some aspects, the RRC reconfiguration message may include SN 720 RRC configuration information in order for the UE 605 to connect to the SN 720, and, additionally, or alternatively, the RRC reconfiguration message may include the one or more QoE and/or RVQoE configurations generated by the MN 725 at step 4 and/or provided to the MN 725 at step 3. More particularly, in aspects in which the SN 720 transmitted the SN-specific QoE and/or RVQoE configuration information to the MN 725 using an XnAP IE or the like, the one or more QoE and/or RVQoE configurations provided at step 5 may include an QoE and/or RVQoE configuration that configures QoE and/or RVQoE measurements and/or metrics and a corresponding periodicity that the SN 720 is requesting from the UE 605, in addition to QoE and/or RVQoE measurements and/or metrics and a corresponding periodicity that the MN 725 is requesting from the UE 605. In aspects in which the SN 720 transmitted the SN-specific QoE and/or RVQoE configuration information to the MN 725 using a CG container or the like, the one or more QoE and/or RVQoE configurations provided at step 5 may include the MN-specific QoE and/or RVQoE configuration generated at step 4, and the SN-specific QoE and/or RVQoE configuration in the CG container.

The UE AS 710 may transmit the one or more QoE and/or RVQoE configurations to the UE APP 705 (step 6), and the UE APP 705 may perform one or more measurements (e.g., collect one or more QoE and/or RVQoE metrics) based at least in part on the one or more QoE and/or RVQoE configurations and thus may report the one or more QoE and/or RVQoE measurements and/or metrics to the UE AS 710 (step 7). These steps may be performed in a substantially similar manner as steps 6 and 7 described above in connection with FIG. 7. In that regard, at step 7, the UE APP 705 may indicate certain identifiers or the like used to determine an interface and/or connectivity (e.g., MN connectivity or SN connectivity) associated with each QoE and/or RVQoE measurement and/or metric, such as a PDU session identifier associated with each QoE and/or RVQoE measurement and/or metric, a QoS flow identifier associated with each QoE and/or RVQoE measurement and/or metric, or the like, as described. The UE AS 710 may determine interface information and/or connectivity (e.g., MN connectivity or SN connectivity) associated with each QoE and/or RVQoE measurement and/or metric (step 8), and the transmit the QoE and/or RVQoE measurement reports and associated interface information to the MN 725 (step 9a), or else transmit MN-applicable QoE and/or RVQoE measurement reports directly to the MN 725 and SN-applicable QoE and/or RVQoE measurement reports directly to the SN 720 (step 9b). Steps 8, 9a, and 9b may be performed in a substantially similar manner as steps 8, 9a, and 9b described above in connection with FIG. 7.

As indicated above, FIG. 8 is provided as an example. Other examples may differ from what is described with respect to FIG. 8.

FIG. 9 is a diagram illustrating another example 900 associated with configuration of QoE and/or RVQoE measurements for a dual connectivity mode, in accordance with the present disclosure.

In the example shown in FIG. 9, the MN 725 and the SN 720 may generate one or more QoE and/or RVQoE configurations independently and/or the MN 725 and the SN 720 may independently configure the UE 605. Put another way, rather than the MN 725 generating a common QoE and/or RVQoE configuration, as described in connection with FIG. 7, or the MN 725 generating one or more QoE and/or RVQoE configurations that include an SN-specific QoE and/or RVQoE configuration component, as described in connection with FIG. 8, in this aspect the MN 725 and the SN 720 may each generate one or more QoE and/or RVQoE configurations (e.g., the MN 725 may generated an MN-specific QoE and/or RVQoE configuration and the SN 720 may generate an SN-specific QoE and/or RVQoE configuration), and/or the MN 725 and the SN 720 may separately configure the UE 605.

More particularly, as shown as step 1, the MN 725 may receive, from the MCE 730, QoE configuration information (e.g., QMC information), including the RVQoE assistance information, as described above in connection with FIGS. 7 and 8. In this aspect, as shown as step 2a, the MN 725 may split the QoE reference between the MN 725 and the SN 720, and thus provide the QoE configuration information (in addition to RVQoE assistance information) to the SN 720 as part of the SN addition request (as shown in this aspect as step 2b). For example, the MN 725 may provide a list of UE application layer measurement configuration information items to the SN 720. In some aspects, each UE application layer measurement configuration information item may include one or more of a QoE reference, a service type, an MCE IP address, a slice scope, an area scope, minimization of drive tests (MDT) alignment information, RRC identifier scope that the SN 720 may allocate (described in more detail below), or the like. In some aspects, the MN 725 may forward all of the UE application layer measurement configuration information items to the SN 720 to perform QoE configuration for all of the items, while, in some other aspects, the MN 725 only forward some of the UE application layer measurement configuration information items to the SN 720 to provide QoE configuration for a subset of the items. In some aspects, the SN 720 may determine which QMC is accepted and provide feedback to the MN 725 accordingly (e.g., using the SN addition request ACK message, shown as step 3). The SN addition request may include additional information used to add the SN 720 as a secondary node for purposes of dual connectivity (e.g., RRC configuration information, radio bearer configuration information, UE capability information, security information such as for purposes of enabling the SRB3, or the like), and/or may include the QMC activation IE, as described above in connection with FIGS. 7 and 8.

Additionally, or alternatively, the SN addition request may include an RRC identifier scope. An RRC identifier may be used to map certain QoE and/or RVQoE measurements and/or metrics to corresponding nodes (e.g., the SN 720 or the MN 725), which is described more fully below. Accordingly, in some aspects, the MN 725 may indicate to the SN 720, via the SN addition request, a scope (e.g., set, range, or the like) of acceptable RRC identifiers that may be utilized by the SN 720 when generating the SN-specific QoE and/or RVQoE configuration. As shown as step 4 associated with the SN 720, the SN 720 may generate an SN-specific QoE and/or RVQoE configuration, which may include allocating one or more RRC identifiers to one or more requested QoE and/or RVQoE measurements and/or metrics. For example, the SN 720 may allocate a first RRC identifier to a first requested QoE and/or RVQoE measurement or metric, the SN 720 may allocate a second RRC identifier to a second requested QoE and/or RVQoE measurement or metric, and so forth. As shown as step 3, the SN 720 may transmit an SN addition request ACK message to the MN 725. Optionally, the SN addition request ACK message may include the SN-specific QoE and/or RVQoE configuration. And as shown as step 4 associated with the MN 725, the MN 725 may generate an MN-specific QoE and/or RVQoE configuration, which may include allocating one or more RRC identifiers to one or more requested QoE and/or RVQoE measurements and/or metrics in a similar manner as described in connection with the SN 720. Although in FIG. 9 the MN 725 is shown as performing step 4 after receiving the SN addition request ACK message, in some other aspects, the MN 725 may generate the MN-specific QoE and/or RVQoE configuration prior to receiving the SN addition request ACK message (e.g., the MN 725 may perform step 4 contemporaneously with SN 720).

In this example, the MN 725 and the SN 720 may separately configure the UE 605 with the respective QoE and/or RVQoE configurations. Thus, as shown as step 5 associated with the MN 725, the MN 725 may transmit, to the UE 605 (more particularly, to the UE AS 710), an RRC reconfiguration message, and, as shown as step 5 associated with the SN 720, the SN 720 may transmit, to the UE AS 710, another RRC reconfiguration message. As described above in connection with FIGS. 7 and 8, each RRC reconfiguration message may include one or more QoE and/or RVQoE configurations, such as the MN-specific QoE and/or RVQoE configuration in the RRC reconfiguration message transmitted by the MN 725 and the SN-specific QoE and/or RVQoE configuration transmitted by the SN 720. Alternatively, one node may forward both the MN-specific QoE and/or RVQoE configuration and the SN-specific QoE and/or RVQoE configuration to the UE 120 at step 5 (e.g., the SN 720 may transmit the SN-specific QoE and/or RVQoE configuration to the MN 725 as part of the SN addition request ACK message, and the MN 725 may transmit both the MN-specific QoE and/or RVQoE configuration and the SN-specific QoE and/or RVQoE configuration to the UE 120 at step 5).

The UE AS 710 may transmit the one or more QoE and/or RVQoE configurations to the UE APP 705 (step 6), and the UE APP 705 may perform one or more measurements based at least in part on the QoE and/or RVQoE configuration and may report the one or more QoE and/or RVQoE measurements and/or metrics to the UE AS 710 (step 7). These steps may be performed in a substantially similar manner as steps 6 and 7 described above in connection with FIGS. 7 and 8. In that regard, at step 7, the UE APP 705 may indicate certain identifiers or the like used to determine an interface and/or connectivity (e.g., MN connectivity or SN connectivity) associated with each QoE and/or RVQoE measurement and/or metric, such as a PDU session identifier associated with each QoE and/or RVQoE measurement and/or metric, a QoS flow identifier associated with each QoE and/or RVQoE measurement and/or metric, or the like, as described. The UE AS 710 may determine interface information and/or connectivity (e.g., MN connectivity or SN connectivity) associated with each QoE and/or RVQoE measurement and/or metric.

In aspects in which the SN 720 and/or the MN 725 allocated RRC identifiers to the respective QoE and/or RVQoE configurations, the RRC identifiers may either be non-overlapped between the SN-specific QoE and/or RVQoE configuration and the MN-specific QoE and/or RVQoE configuration, or else may be overlapped between the SN-specific QoE and/or RVQoE configuration and the MN-specific QoE and/or RVQoE configuration. For example, as described above in connection with the SN addition request at step 2b, in some aspects the MN 725 may have provided the SN with an RRC identifier scope such that the RRC identifiers allocated by the SN to the SN-specific QoE and/or RVQoE configuration do not overlap with RRC identifiers allocated by the MN to the MN-specific QoE and/or RVQoE configuration. In such aspects, when determining the interface information at step 8, the UE 605 may determine the interface information on which the application for the reported QoE and/or RVQoE measurement is running over, and then may report the measurement to the corresponding RAN node (e.g., MN 725 or SN 720) if the interface information for the measurement is aligned with the RAN node providing the corresponding QoE and/or RVQoE configuration indicated by the RRC identifier. On the other hand, if the interface information for the measurement is not aligned with the RAN node providing the corresponding QoE and/or RVQoE configuration indicated by the RRC identifier, the UE 605 may drop the measurement report or else report the measurement to the RAN node indicated by the interface information. In the latter instance, the UE 605 may provide the RAN node with an indication that the other RAN node provided a configuration corresponding to the reported measurement.

For example, the MN 725 may provide an MN-specific QoE and/or RVQoE configuration to the UE 605 that configures QoE and/or RVQoE measurements and/or metrics associated with two RRC identifiers: RRC ID-1 and RRC ID-2. Similarly, the SN 720 may provide an SN-specific QoE and/or RVQoE configuration to the UE 605 that configures QoE and/or RVQoE measurements and/or metrics associated with two, non-overlapping RRC identifiers: RRC ID-3 and RRC ID-4. If a first application associated with RRC ID-3 (which, in this example, was indicated by the SN-specific QoE and/or RVQoE configuration) is running over the MN interface and a second application associated with RRC ID-4 (which, in this example, was indicated by the SN-specific QoE and/or RVQoE configuration) is running over the SN interface, the UE 605 may report the QoE and/or RVQoE measurement and/or metric associated with RRC ID-4 to the SN, because that RRC identifier was indicated by the SN-specific QoE and/or RVQoE configuration. For the QoE and/or RVQoE measurement and/or metric associated with RRC ID-3, the UE 605 may drop reporting of the QoE and/or RVQoE measurement and/or metric because the application is running over MN connectivity but the corresponding RRC identifier was not indicated by the MN 725, or else the UE 605 may report the QoE and/or RVQoE measurement and/or metric to the MN 725, optionally with an indication that the SN 720 provided a configuration corresponding to the reported the QoE and/or RVQoE measurement and/or metric.

In some other aspects, the MN 725 may not provide RRC identifier scope information to the SN 720 in connection with the SN addition request and/or RRC identifiers associated with the SN-specific QoE and/or RVQoE configuration and the MN-specific QoE and/or RVQoE configuration may otherwise overlap. Put another way, in some aspects, the UE 605 may receive the same RRC identifier from the MN 725 and the SN 720. In some aspects, when the QoE and/or RVQoE configurations include overlapping RRC identifiers, the UE AS 710 may forward only the QoE and/or QoE and/or RVQoE configuration associated with a predetermined RAN node (e.g., the MN 725) to the UE APP 705, may forward only a latest QoE and/or RVQoE configuration to the UE APP 705, or may forward both QoE and/or RVQoE configurations to the UE APP 705 and the UE APP 705 may determine which QoE and/or RVQoE configuration should be used based on a connectivity used for the corresponding application or otherwise.

For example, the MN 725 may provide an MN-specific QoE and/or RVQoE configuration to the UE 605 that configures QoE and/or RVQoE measurements and/or metrics associated with two RRC identifiers: RRC ID-1 and RRC ID-2. Similarly, the SN 720 may provide an SN-specific QoE and/or RVQoE configuration to the UE 605 that configures QoE and/or RVQoE measurements and/or metrics also associated RRC ID-1 and RRC ID-2. Accordingly, because of the overlapping RRC identifiers, the UE AS 710 may forward only the MN-specific QoE and/or RVQoE configuration to the UE APP 705 (or, alternatively, may forward only the SN-specific QoE and/or RVQoE configuration to the UE APP 705). Alternatively, the UE AS 710 may forward the latest (e.g., later-received) QoE and/or RVQoE configuration to the UE APP 705. In some other aspects, the UE AS 710 may forward QoE and/or RVQoE configurations to the UE APP 705 even if certain configurations include overlapping RRC identifiers, and, if the UE APP 710 receive two QoE and/or RVQoE configurations with the same RRC identifier, the UE APP 710 may overwrite a first-received QoE and/or RVQoE configuration with a later-received QoE and/or RVQoE configuration. Alternatively, the UE AS 710 may forward both QoE and/or RVQoE configurations to the UE APP 705, and the UE APP 705 may determine that the MN-specific QoE and/or RVQoE configuration should be used for the measurements associated with RRC ID-1 (because the first application is running over the MN interface), while the SN-specific QoE and/or RVQoE configuration should be used for the measurements associated with RRC ID-2 (because the second application is running over the SN interface). When reporting the QoE and/or RVQoE measurements and/or metrics, the UE 605 may report the QoE and/or RVQoE measurement and/or metric associated with RRC ID-1 to the MN 725, because the first application associated with RRC ID-1 was indicated by the MN-specific QoE and/or RVQoE configuration and because the first application associated with RRC ID-1 is operating on the MN interface. Similarly, the UE 605 may report the QoE and/or RVQoE measurement and/or metric associated with RRC ID-2 to the SN 720, because the second application associated with RRC ID-2 was indicated by the SN-specific QoE and/or RVQoE configuration and because the second application associated with RRC ID-2 is operating on the SN interface.

Moreover, and as described above in connection with FIGS. 7 and 8, the UE 605 may transmit the QoE and/or RVQoE measurements and/or metrics and associated interface information to the MN 725 (step 9a), or else transmit MN-applicable QoE and/or RVQoE measurements and/or metrics directly to the MN 725 and SN-applicable QoE and/or RVQoE measurements and/or metrics directly to the SN 720 (step 9b). Steps 9a, and 9b may be performed in a substantially similar manner as steps 9a, and 9b described above in connection with FIGS. 7 and 8.

As indicated above, FIG. 9 is provided as an example. Other examples may differ from what is described with respect to FIG. 9.

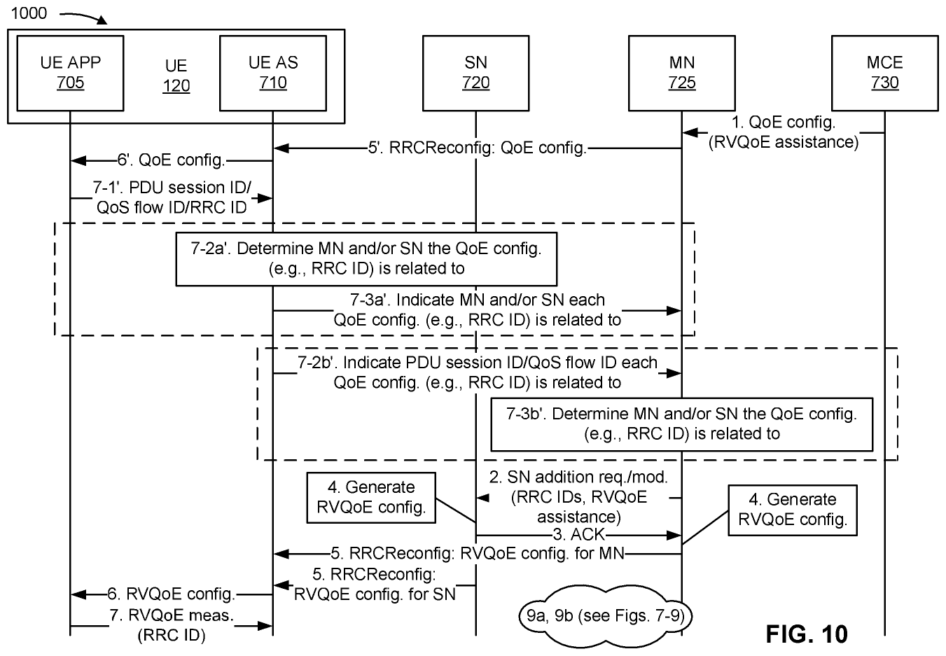

FIG. 10 is a diagram illustrating another example 1000 associated with configuration of RVQoE measurements for a dual connectivity mode, in accordance with the present disclosure.

In the example shown in FIG. 10, the MN 725 and/or the SN 720 may generate QoE and/or RVQoE configurations with assistance from the UE 605. More particularly, as shown as step 1, the MN 725 may receive, from the MCE 730, QoE configuration information (e.g., QMC information), including the RVQoE assistance information, as described above in connection with FIGS. 7-9. In this aspect, as shown as step 5′, the MN 725 transmit the QoE configuration information to the UE 605 (and, more particularly, to the UE AS 710) via an RRC message, such as an RRC reconfiguration message. The UE AS 710 may forward the QoE configuration to the UE APP 705, as shown as step 6′. As shown as step 7-1′, the UE APP 705 may, in turn, transmit to the UE AS 710 information associated with each configured QoE measurement, such as a corresponding PDU session identifier for each configured QoE measurement, a QoS flow identifier for each configured QoE measurement, an RRC identifier for each configured QoE measurement, or similar identifying information.

In some aspects, the UE AS 705 may then map the identifying information to a corresponding interface (e.g., one of the MN interface or the SN interface), or else the UE AS 710 may forward the identifying information to a RAN node (e.g., the MN 725) for mapping the identifying information to a corresponding interface. More particularly, as shown as step 7-2a′, in a first alternative the UE AS 710 determines which interface (e.g., which of the MN interface or the SN interface) each QoE measurement is related to. The UE AS 710 may do so by mapping a PDU session identifier for each QoE measurement to a corresponding interface, by mapping a QoS flow identifier for each QoE measurement to a corresponding interface, by mapping an RRC identifier for each QoE measurement to a corresponding interface, or by mapping other identifying information for each QoE measurement to a corresponding interface. In such aspects, and as shown as step 7-3a′, the UE AS 710 may then indicate to one or more RAN nodes (e.g., the MN 725) which QoE measurements are associated with each interfaces.

In a second alternative, the UE AS 710 may transmit identifying information to a RAN node (e.g., the MN 725), and the RAN node may thus determine which QoE measurements apply to each interface. More particularly, as shown as step 7-2b′, the UE AS 710 may transmit, to the MN 725, a PDU session identifier for each QoE measurement, a QoS flow identifier for each QoE measurement, an RRC identifier for each QoE measurement, or other identifying information for each QoE measurement. As shown as step 7-3b′, the MN 725 may then determine which interface (e.g., which of the MN interface or the SN interface) each QoE measurement is related to. The MN 725 may do so by mapping a PDU session identifier for each QoE measurement to a corresponding interface, by mapping a QoS flow identifier for each QoE measurement to a corresponding interface, by mapping an RRC identifier for each QoE measurement to a corresponding interface, or by mapping other identifying information for each QoE measurement to a corresponding interface.

As shown as step 2 in FIG. 10, the MN 725 may then forward information to the SN 720 to be used by the SN 720 for generating an SN-specific QoE and/or RVQoE configuration. The information may be transmitted to the SN 720 using an SN addition request and/or modification message, and, in some aspects, may include RRC identifiers associated with QoE measurements of applications associated with the SN interface, and/or other RVQoE assistance information. As show as step 4 associated with the SN 720, the SN may thus generate an SN-specific QoE and/or RVQoE configuration, which may configure one or more QoE and/or RVQoE measurements and/or metrics associated with applications associated with SN connectivity. As shown as step 3, the SN 720 may transmit an SN addition request and/or modification ACK to the MN 725, which, in some aspects, may optionally include the SN-specific QoE and/or RVQoE configuration. Similarly, as shown as step 4 associated with the MN 725, the MN 725 may generate an MN-specific QoE and/or RVQoE configuration, which in some aspects may be generated after receiving the SN addition request and/or modification message, but which, in some other aspects, may be generated at a different time (such as contemporaneous with the SN 720 generating the SN-specific QoE and/or RVQoE configuration).

Then, as shown as step 5, the MN-specific QoE and/or RVQoE configuration and the SN-configuration may be transmitted to the UE 605 (more particularly, to the UE AS 710). As described above, the SN-specific QoE and/or RVQoE configuration may be provided over the SN interface or over the MN interface. For example, in some aspects the MN 725 may transmit, to the UE 605, an RRC reconfiguration message or the like that includes both the MN-specific QoE and/or RVQoE configuration and the SN-specific QoE and/or RVQoE configuration. In some other aspects, the MN 725 may transmit, to the UE 605, an RRC reconfiguration message or the like that includes the MN-specific QoE and/or RVQoE configuration, and the SN 720 may separately transmit, to the UE 605, an RRC reconfiguration message or the like that includes the SN-specific QoE and/or RVQoE configuration.

As shown as step 6, the UE AS 710 may forward the QoE and/or RVQoE configurations (e.g., the MN-specific QoE and/or RVQoE configuration and the SN-specific QoE and/or RVQoE configuration) to the UE APP 705, which may perform the configured measurements, and, as shown as step 7, and which may report the QoE and/or RVQoE measurements and/or metrics to the UE AS 710. In some aspects, the UE APP 705 may indicate a corresponding RRC identifier for each reported QoE and/or RVQoE measurement and/or metric. The UE AS 710 may report the QoE and/or RVQoE measurements and/or metrics to the MN 725 and/or the SN 720 in a similar manner as described above in connection with steps 9a or 9b, described in connection with FIGS. 7-9.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 605) performs operations associated with RVQoE metrics for a dual connectivity mode. Although for ease of discussion the process 1100 is described in connection with RVQoE configurations, measurements, and reporting, in some other aspects, the process 1100 may be used for configuring, measuring, and reporting QoE metrics in a substantially similar manner, as described in connection with FIGS. 7-10.

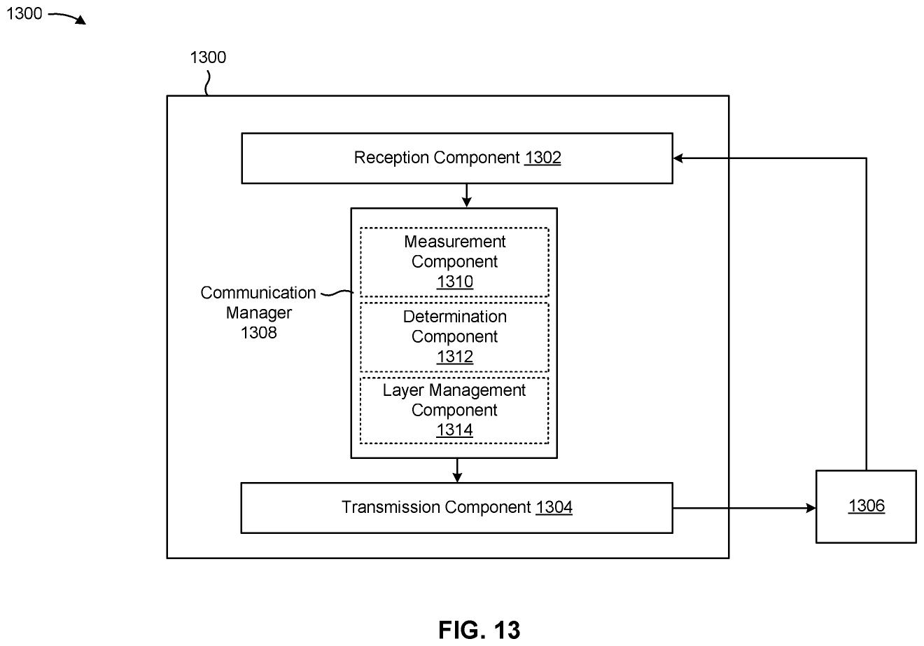

As shown in FIG. 11, in some aspects, process 1100 may include receiving, from at least one of an MN or an SN, one or more RVQoE configurations, wherein the UE is operating in a dual connectivity mode with the MN and the SN (block 1110). For example, the UE (e.g., using communication manager 1308 and/or reception component 1302, depicted in FIG. 13) may receive, from at least one of an MN or an SN, one or more RVQoE configurations, wherein the UE is operating in a dual connectivity mode with the MN and the SN, as described above.

As further shown in FIG. 11, in some aspects, process 1100 may include transmitting, to at least one of the MN or the SN, at least one RVQoE measurement report based at least in part on the one or more RVQoE configurations (block 1120). For example, the UE (e.g., using communication manager 1308 and/or transmission component 1304, depicted in FIG. 13) may transmit, to at least one of the MN or the SN, at least one RVQoE measurement report based at least in part on the one or more RVQoE configurations, as described above.

Process 1100 may include additional aspects, such as any single aspect or any combination of aspects described below and/or in connection with one or more other processes described elsewhere herein.

In a first aspect, the one or more RVQoE configurations includes a common RVQoE configuration received from the MN.

In a second aspect, alone or in combination with the first aspect, the one or more RVQoE configurations includes an MN-specific RVQoE configuration and an SN-specific RVQoE configuration.

In a third aspect, alone or in combination with one or more of the first and second aspects, the SN-specific RVQoE configuration is based at least in part on a list of available RVQoE configurations provided by the MN to the SN.

In a fourth aspect, alone or in combination with one or more of the first through third aspects, the MN-specific RVQoE configuration and the SN-specific RVQoE configuration are received from the MN.

In a fifth aspect, alone or in combination with one or more of the first through fourth aspects, the SN-specific RVQoE configuration is based at least in part on configuration information provided to the MN from the SN via an Xn application protocol information element.

In a sixth aspect, alone or in combination with one or more of the first through fifth aspects, the SN-specific RVQoE configuration is based at least in part on configuration information provided to the MN from the SN via a cell group container.

In a seventh aspect, alone or in combination with one or more of the first through sixth aspects, the MN-specific RVQoE configuration is received from the MN and the SN-specific RVQoE configuration is received from the SN.

In an eighth aspect, alone or in combination with one or more of the first through seventh aspects, the SN-specific RVQoE configuration is received from the SN via a signaling radio bearer.

In a ninth aspect, alone or in combination with one or more of the first through eighth aspects, the MN-specific RVQoE configuration and the SN-specific RVQoE configuration are based at least in part on the UE providing an indication to the MN that a first set of one or more RVQoE configurations are associated with the MN and that a second set of one or more RVQoE configurations are associated with the SN.

In a tenth aspect, alone or in combination with one or more of the first through ninth aspects, process 1100 includes collecting at least one RVQoE metric based at least in part on the one or more RVQoE configurations, and determining whether each RVQoE configuration is associated with one of MN connectivity or SN connectivity.

In an eleventh aspect, alone or in combination with one or more of the first through tenth aspects, the UE transmits at least one RVQoE measurement report to the MN.

In a twelfth aspect, alone or in combination with one or more of the first through eleventh aspects, the at least one RVQoE measurement report includes a first RVQoE measurement report associated with the MN and a second RVQoE measurement report associated with the SN, and the UE transmits, to the MN, at least one of interface information or bearer information indicating that the first RVQoE measurement report is associated with the MN and that the second RVQoE measurement report is associated with the SN.

In a thirteenth aspect, alone or in combination with one or more of the first through twelfth aspects, the at least one of interface information or bearer information includes at least one of an indication of one of MN connectivity or SN connectivity, an indication of one of an MCG bearer or a SCG bearer, an indication of one of an MCG leg of a split bearer or an SCG leg of a split bearer, a bearer identifier, a packet data unit session identifier, or a quality of service flow identifier.

In a fourteenth aspect, alone or in combination with one or more of the first through thirteenth aspects, the at least one RVQoE measurement report includes a first RVQoE measurement report associated with the MN and a second RVQoE measurement report associated with the SN, and the UE transmits the first RVQoE measurement report to the MN and the second RVQoE measurement report to the SN.

In a fifteenth aspect, alone or in combination with one or more of the first through fourteenth aspects, the one or more RVQoE configurations includes an MN-specific RVQoE configuration and an SN-specific RVQoE configuration, the MN-specific RVQoE configuration is associated with a first set of one or more RRC identifiers, and the SN-specific RVQoE configuration is associated with a second set of one or more RRC identifiers.

In a sixteenth aspect, alone or in combination with one or more of the first through fifteenth aspects, the first set of one or more RRC identifiers includes a first RRC identifier, and the second set of one or more RRC identifiers includes a second RRC identifier different than the first RRC identifier.

In a seventeenth aspect, alone or in combination with one or more of the first through sixteenth aspects, process 1100 includes at least one of reporting a first RVQoE measurement report associated with the first RRC identifier to the MN based at least in part on an application associated with the first RRC identifier being associated with MN connectivity, or reporting a second RVQoE measurement report associated with the second RRC identifier to the SN based at least in part on an application associated with the second RRC identifier being associated with SN connectivity.

In an eighteenth aspect, alone or in combination with one or more of the first through seventeenth aspects, process 1100 includes at least one of dropping reporting of a first RVQoE measurement report associated with the second RRC identifier based at least in part on an application associated with the second RRC identifier being associated with MN connectivity, or reporting the first RVQoE measurement report associated with the second RRC identifier to the MN with an indication of SN connectivity associated with the RVQoE measurement report based at least in part on an application associated with the second RRC identifier being associated with SN connectivity.

In a nineteenth aspect, alone or in combination with one or more of the first through eighteenth aspects, the first set of one or more RRC identifiers and the second set of one or more RRC identifiers includes a first RRC identifier.

In a twentieth aspect, alone or in combination with one or more of the first through nineteenth aspects, process 1100 includes transmitting, from an access stratum layer of the UE to an application layer of the UE, the MN-specific RVQoE configuration based at least in part on the first set of one or more RRC identifiers and the second set of one or more RRC identifiers including the first RRC identifier.

In a twenty-first aspect, alone or in combination with one or more of the first through twentieth aspects, process 1100 includes transmitting, from an access stratum layer of the UE to an application layer of the UE, a latest-received RVQoE configuration of the MN-specific RVQoE configuration or the SN-specific RVQoE configuration based at least in part on the first set of one or more RRC identifiers and the second set of one or more RRC identifiers including the first RRC identifier.

In a twenty-second aspect, alone or in combination with one or more of the first through twenty-first aspects, process 1100 includes transmitting, from an access stratum layer of the UE to an application layer of the UE, the MN-specific RVQoE configuration and the SN-specific RVQoE configuration based at least in part on the first set of one or more RRC identifiers and the second set of one or more RRC identifiers including the first RRC identifier, and determining whether to use the MN-specific RVQoE configuration and the SN-specific RVQoE configuration based at least in part on a connectivity of an application associated with the first RRC identifier.

In a twenty-third aspect, alone or in combination with one or more of the first through twenty-second aspects, the first set of one or more RRC identifiers and the second set of one or more RRC identifiers include a first RRC identifier and a second RRC identifier, the UE reports a first RVQoE measurement report associated with first RRC identifier to the MN based at least in part on an application associated with the first RRC identifier being associated with MN connectivity, and the UE reports a second RVQoE measurement report associated with the second RRC identifier to the SN based at least in part on an application associated with the second RRC identifier being associated with SN connectivity.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by an MN, in accordance with the present disclosure. Example process 1200 is an example where the MN (e.g., MN 610, MN 725) performs operations associated with RVQoE metrics for a dual connectivity mode. Although for ease of discussion the process 1200 is described in connection with RVQoE configurations, measurements, and reporting, in some other aspects, the process 1200 may be used for configuring, measuring, and reporting QoE metrics in a substantially similar manner, as described in connection with FIGS. 7-10.

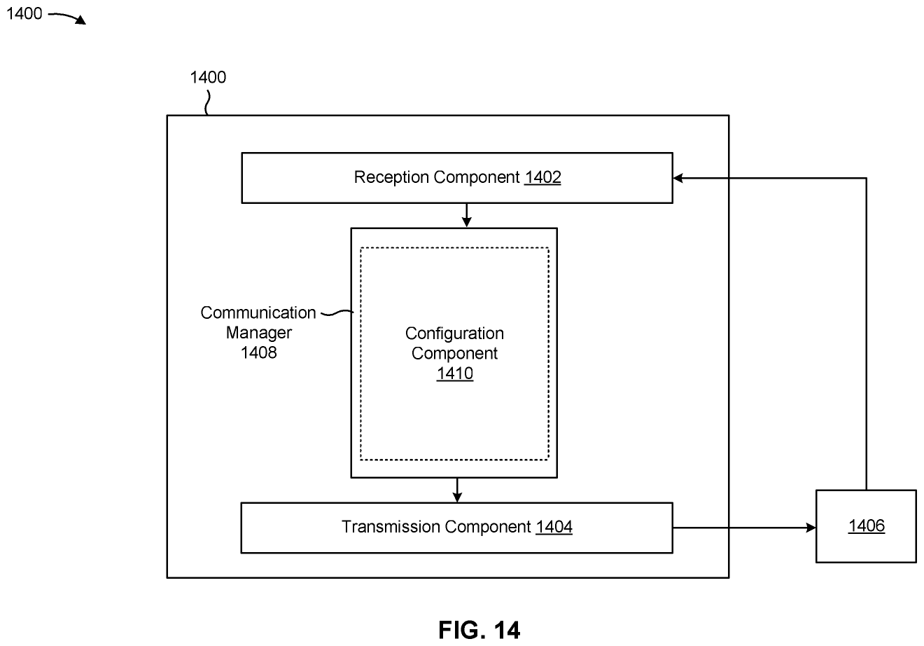

As shown in FIG. 12, in some aspects, process 1200 may include transmitting, to a UE (e.g., UE 605), one or more RVQoE configurations, wherein the UE is operating in a dual connectivity mode with the MN and an SN (block 1210). For example, the MN (e.g., using communication manager 1408 and/or transmission component 1404, depicted in FIG. 14) may transmit, to a UE, one or more RVQoE configurations, wherein the UE is operating in a dual connectivity mode with the MN and an SN, as described above.

As further shown in FIG. 12, in some aspects, process 1200 may include receiving, from the UE, at least one RVQoE measurement report based at least in part on the one or more RVQoE configurations (block 1220). For example, the MN (e.g., using communication manager 1408 and/or reception component 1402, depicted in FIG. 14) may receive, from the UE, at least one RVQoE measurement report based at least in part on the one or more RVQoE configurations, as described above.

Process 1200 may include additional aspects, such as any single aspect or any combination of aspects described below and/or in connection with one or more other processes described elsewhere herein.

In a first aspect, the one or more RVQoE configurations includes a common RVQoE.

In a second aspect, alone or in combination with the first aspect, the one or more RVQoE configurations includes an MN-specific RVQoE configuration and an SN-specific RVQoE configuration.

In a third aspect, alone or in combination with one or more of the first and second aspects, the SN-specific RVQoE configuration is based at least in part on a list of available RVQoE configurations provided by the MN to the SN.

In a fourth aspect, alone or in combination with one or more of the first through third aspects, the SN-specific RVQoE configuration is based at least in part on configuration information provided to the MN from the SN via an Xn application protocol information element.

In a fifth aspect, alone or in combination with one or more of the first through fourth aspects, the SN-specific RVQoE configuration is based at least in part on configuration information provided to the MN from the SN via a cell group container.

In a sixth aspect, alone or in combination with one or more of the first through fifth aspects, the one or more RVQoE configurations includes only one or more MN-specific RVQoE configurations.

In a seventh aspect, alone or in combination with one or more of the first through sixth aspects, the one or more MN-specific RVQoE configurations are based at least in part on the UE providing an indication to the MN that a set of one or more RVQoE configurations are associated with the MN.

In an eighth aspect, alone or in combination with one or more of the first through seventh aspects, the at least one RVQoE measurement report includes a first RVQoE measurement report associated with the MN and a second RVQoE measurement report associated with the SN, and the MN receives, from the UE, at least one of interface information or bearer information indicating that the first RVQoE measurement report is associated with the MN and that the second RVQoE measurement report is associated with the SN.

In a ninth aspect, alone or in combination with one or more of the first through eighth aspects, the at least one of interface information or bearer information includes at least one of an indication of one of MN connectivity or SN connectivity, an indication of one of an MCG bearer or an SCG bearer, an indication of one of an MCG leg of a split bearer or an SCG leg of a split bearer, a bearer identifier, a packet data unit session identifier, or a quality of service flow identifier.

In a tenth aspect, alone or in combination with one or more of the first through ninth aspects, the one or more RVQoE configurations includes an MN-specific RVQoE configuration and an SN-specific RVQoE configuration, the MN-specific RVQoE configuration is associated with a first set of one or more RRC identifiers, and the SN-specific RVQoE configuration is associated with a second set of one or more RRC identifiers.

In an eleventh aspect, alone or in combination with one or more of the first through tenth aspects, the first set of one or more RRC identifiers includes a first RRC identifier, and the second set of one or more RRC identifiers includes a second RRC identifier different than the first RRC identifier.

In a twelfth aspect, alone or in combination with one or more of the first through eleventh aspects, process 1200 includes receiving, from the UE, an RVQoE measurement report associated with the first RRC identifier based at least in part on an application associated with the first RRC identifier being associated with MN connectivity.

In a thirteenth aspect, alone or in combination with one or more of the first through twelfth aspects, process 1200 includes receiving, from the UE, an RVQoE measurement report associated with the second RRC identifier with an indication of SN connectivity associated with the RVQoE measurement report based at least in part on an application associated with the second RRC identifier being associated with SN connectivity.

In a fourteenth aspect, alone or in combination with one or more of the first through thirteenth aspects, the first set of one or more RRC identifiers and the second set of one or more RRC identifiers include a first RRC identifier and a second RRC identifier, and the MN receives from the UE a first RVQoE measurement report associated with first RRC identifier based at least in part on an application associated with the first RRC identifier being associated with MN connectivity, and the MN does not receive from the UE a second RVQoE measurement report associated with the second RRC identifier based at least in part on an application associated with the second RRC identifier being associated with SN connectivity.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE (e.g., UE 605), or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308 (e.g., communication manager 140). The communication manager 1308 may include one or more of a measurement component 1310, a determination component 1312, or a layer management component 1314, among other examples.

In some aspects, the apparatus 1300 may be configured to perform one or more operations described herein in connection with FIGS. 6-10. Additionally, or alternatively, the apparatus 1300 may be configured to perform one or more processes described herein, such as process 1100 of 11. In some aspects, the apparatus 1300 and/or one or more components shown in FIG. 13 may include one or more components of the UE 120 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE 120 described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE 120 described in connection with FIG. 2. In some aspects, the transmission component 1304 may be co-located with the reception component 1302 in a transceiver.

The reception component 1302 may receive, receiving, from at least one of an MN or an SN, one or more RVQoE configurations, wherein the UE is operating in a dual connectivity mode with the MN and the SN. The transmission component 1304 may transmit, to at least one of the MN or the SN, at least one RVQoE measurement report based at least in part on the one or more RVQoE configurations.

The measurement component 1310 may collect at least one RVQoE metric based at least in part on the one or more RVQoE configurations.

The determination component 1312 may determine whether each RVQoE configuration is associated with one of MN connectivity or SN connectivity.

The transmission component 1304 and/or the measurement component 1310 may report a first RVQoE measurement report associated with the first RRC identifier to the MN based at least in part on an application associated with the first RRC identifier being associated with MN connectivity, or report a second RVQoE measurement report associated with the second RRC identifier to the SN based at least in part on an application associated with the second RRC identifier being associated with SN connectivity.

The transmission component 1304 and/or the measurement component 1310 may drop reporting of a first RVQoE measurement report associated with the second RRC identifier based at least in part on an application associated with the second RRC identifier being associated with MN connectivity, or may report the first RVQoE measurement report associated with the second RRC identifier to the MN with an indication of SN connectivity associated with the RVQoE measurement report based at least in part on an application associated with the second RRC identifier being associated with SN connectivity.

The layer management component 1314 may transmit, from an access stratum layer of the UE to an application layer of the UE, the MN-specific RVQoE configuration based at least in part on the first set of one or more RRC identifiers and the second set of one or more RRC identifiers including the first RRC identifier.

The layer management component 1314 may transmit, from an access stratum layer of the UE to an application layer of the UE, a latest-received RVQoE configuration of the MN-specific RVQoE configuration or the SN-specific RVQoE configuration based at least in part on the first set of one or more RRC identifiers and the second set of one or more RRC identifiers including the first RRC identifier.

The layer management component 1314 may transmit, from an access stratum layer of the UE to an application layer of the UE, the MN-specific RVQoE configuration and the SN-specific RVQoE configuration based at least in part on the first set of one or more RRC identifiers and the second set of one or more RRC identifiers including the first RRC identifier.

The determination component 1312 may determine whether to use the MN-specific RVQoE configuration and the SN-specific RVQoE configuration based at least in part on a connectivity of an application associated with the first RRC identifier.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 9 is a diagram of an example apparatus 1400 for wireless communication, in accordance with the present disclosure. The apparatus 1400 may be a MN (e.g., MN 610 or MN 725), or a MN may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408 (e.g., communication manager 150). The communication manager 1408 may include a configuration component 1410, among other examples.

In some aspects, the apparatus 1400 may be configured to perform one or more operations described herein in connection with FIGS. 6-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the base station 110 described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station 110 described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station 110 described in connection with FIG. 2. In some aspects, the transmission component 1404 may be co-located with the reception component 1402 in a transceiver.

The transmission component 1404 and/or the configuration component 1410 may transmit, to a UE, one or more RVQoE configurations, wherein the UE is operating in a dual connectivity mode with the MN and an SN. The reception component 1402 may receive, from the UE, at least one RVQoE measurement report based at least in part on the one or more RVQoE configurations.

The reception component 1402 may receive, from the UE, an RVQoE measurement report associated with the first RRC identifier based at least in part on an application associated with the first RRC identifier being associated with MN connectivity.

The reception component 1402 may receive, from the UE, an RVQoE measurement report associated with the second RRC identifier with an indication of SN connectivity associated with the RVQoE measurement report based at least in part on an application associated with the second RRC identifier being associated with SN connectivity.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in Fig.

The following provides an overview of some Aspects of the present disclosure:

Aspect 1: A method of wireless communication performed by a UE, comprising: receiving, from at least one of an MN or an SN, one or more RVQoE configurations, wherein the UE is operating in a dual connectivity mode with the MN and the SN; and transmitting, to at least one of the MN or the SN, at least one RVQoE measurement report based at least in part on the one or more RVQoE configurations.

Aspect 2: The method of Aspects 1, wherein the one or more RVQoE configurations includes a common RVQoE configuration received from the MN.

Aspect 3: The method of any of Aspects 1-2, wherein the one or more RVQoE configurations includes an MN-specific RVQoE configuration and an SN-specific RVQoE configuration.

Aspect 4: The method of Aspect 2, wherein the SN-specific RVQoE configuration is based at least in part on a list of available RVQoE configurations provided by the MN to the SN.

Aspect 5: The method of any of Aspects 3-4, wherein the MN-specific RVQoE configuration and the SN-specific RVQoE configuration are received from the MN.

Aspect 6: The method of Aspect 5, wherein the SN-specific RVQoE configuration is based at least in part on configuration information provided to the MN from the SN via an Xn application protocol information element.

Aspect 7: The method of Aspect 5, wherein the SN-specific RVQoE configuration is based at least in part on configuration information provided to the MN from the SN via a cell group container.

Aspect 8: The method of Aspect 3, wherein the MN-specific RVQoE configuration is received from the MN and the SN-specific RVQoE configuration is received from the SN.

Aspect 9: The method of Aspect 8, wherein the SN-specific RVQoE configuration is received from the SN via a signaling radio bearer.

Aspect 10: The method of any of Aspects 8-9, wherein the MN-specific RVQoE configuration and the SN-specific RVQoE configuration are based at least in part on the UE providing an indication to the MN that a first set of one or more RVQoE configurations are associated with the MN and that a second set of one or more RVQoE configurations are associated with the SN.

Aspect 11: The method of any of Aspects 1-10, further comprising: collecting at least one RVQoE metric based at least in part on the one or more RVQoE configurations; and determining whether each RVQoE configuration is associated with one of MN connectivity or SN connectivity.

Aspect 12: The method of any of Aspects 1-11, wherein the UE transmits at least one RVQoE measurement report to the MN.

Aspect 13: The method of Aspect 12, wherein the at least one RVQoE measurement report includes a first RVQoE measurement report associated with the MN and a second RVQoE measurement report associated with the SN, and wherein the UE transmits, to the MN, at least one of interface information or bearer information indicating that the first RVQoE measurement report is associated with the MN and that the second RVQoE measurement report is associated with the SN.

Aspect 14: The method of Aspects 13, wherein the at least one of interface information or bearer information includes at least one of an indication of one of MN connectivity or SN connectivity, an indication of one of an MCG bearer or an SCG bearer, an indication of one of an MCG leg of a split bearer or an SCG leg of a split bearer, a bearer identifier, a packet data unit session identifier, or a quality of service flow identifier.

Aspect 15: The method of any of Aspects 1-14, wherein the at least one RVQoE measurement report includes a first RVQoE measurement report associated with the MN and a second RVQoE measurement report associated with the SN, and wherein the UE transmits the first RVQoE measurement report to the MN and the second RVQoE measurement report to the SN.

Aspect 16: The method of any of Aspects 1-15, wherein the one or more RVQoE configurations includes an MN-specific RVQoE configuration and an SN-specific RVQoE configuration, wherein the MN-specific RVQoE configuration is associated with a first set of one or more RRC identifiers, and wherein the SN-specific RVQoE configuration is associated with a second set of one or more RRC identifiers.

Aspect 17: The method of Aspect 16, wherein the first set of one or more RRC identifiers includes a first RRC identifier, and wherein the second set of one or more RRC identifiers includes a second RRC identifier different than the first RRC identifier.

Aspect 18: The method of Aspect 17, further comprising at least one of: reporting a first RVQoE measurement report associated with the first RRC identifier to the MN based at least in part on an application associated with the first RRC identifier being associated with MN connectivity: or reporting a second RVQoE measurement report associated with the second RRC identifier to the SN based at least in part on an application associated with the second RRC identifier being associated with SN connectivity.

Aspect 19: The method of Aspect 17, further comprising at least one of: dropping reporting of a first RVQoE measurement report associated with the second RRC identifier based at least in part on an application associated with the second RRC identifier being associated with MN connectivity: or reporting the first RVQoE measurement report associated with the second RRC identifier to the MN with an indication of SN connectivity associated with the RVQoE measurement report based at least in part on an application associated with the second RRC identifier being associated with SN connectivity.

Aspect 20: The method of Aspect 16, wherein the first set of one or more RRC identifiers and the second set of one or more RRC identifiers includes a first RRC identifier.

Aspect 21: The method of Aspect 20, further comprising transmitting, from an access stratum layer of the UE to an application layer of the UE, the MN-specific RVQoE configuration based at least in part on the first set of one or more RRC identifiers and the second set of one or more RRC identifiers including the first RRC identifier.

Aspect 22: The method of Aspect 20, further comprising transmitting, from an access stratum layer of the UE to an application layer of the UE, a latest-received RVQoE configuration of the MN-specific RVQoE configuration or the SN-specific RVQoE configuration based at least in part on the first set of one or more RRC identifiers and the second set of one or more RRC identifiers including the first RRC identifier.

Aspect 23: The method of Aspect 20, further comprising: transmitting, from an access stratum layer of the UE to an application layer of the UE, the MN-specific RVQoE configuration and the SN-specific RVQoE configuration based at least in part on the first set of one or more RRC identifiers and the second set of one or more RRC identifiers including the first RRC identifier; and determining whether to use the MN-specific RVQoE configuration and the SN-specific RVQoE configuration based at least in part on a connectivity of an application associated with the first RRC identifier.

Aspect 24: The method of Aspect 16, wherein the first set of one or more RRC identifiers and the second set of one or more RRC identifiers include a first RRC identifier and a second RRC identifier, wherein the UE reports a first RVQoE measurement report associated with first RRC identifier to the MN based at least in part on an application associated with the first RRC identifier being associated with MN connectivity, and wherein the UE reports a second RVQoE measurement report associated with the second RRC identifier to the SN based at least in part on an application associated with the second RRC identifier being associated with SN connectivity.

Aspect 25: A method of wireless communication performed by an MN, comprising: transmitting, to a UE, one or more RVQoE configurations, wherein the UE is operating in a dual connectivity mode with the MN and an SN; and receiving, from the UE, at least one RVQoE measurement report based at least in part on the one or more RVQoE configurations.

Aspect 26: The method of Aspect 25, wherein the one or more RVQoE configurations includes a common RVQoE.

Aspect 27: The method of any of Aspects 25-26, wherein the one or more RVQoE configurations includes an MN-specific RVQoE configuration and an SN-specific RVQoE configuration.

Aspect 28: The method of Aspect 27, wherein the SN-specific RVQoE configuration is based at least in part on a list of available RVQoE configurations provided by the MN to the SN.

Aspect 29: The method of any of Aspects 27-28, wherein the SN-specific RVQoE configuration is based at least in part on configuration information provided to the MN from the SN via an Xn application protocol information element.

Aspect 30: The method of any of Aspects 27-28, wherein the SN-specific RVQoE configuration is based at least in part on configuration information provided to the MN from the SN via a cell group container.

Aspect 31: The method of Aspect 25, wherein the one or more RVQoE configurations includes only one or more MN-specific RVQoE configurations.

Aspect 32: The method of any of Aspect 31, wherein the one or more MN-specific RVQoE configurations are based at least in part on the UE providing an indication to the MN that a set of one or more RVQoE configurations are associated with the MN.

Aspect 33: The method of any of Aspects 25-32, wherein the at least one RVQoE measurement report includes a first RVQoE measurement report associated with the MN and a second RVQoE measurement report associated with the SN, and wherein the MN receives, from the UE, at least one of interface information or bearer information indicating that the first RVQoE measurement report is associated with the MN and that the second RVQoE measurement report is associated with the SN.

Aspect 34: The method of Aspect 33, wherein the at least one of interface information or bearer information includes at least one of an indication of one of MN connectivity or SN connectivity, an indication of one of an MCG bearer or an SCG bearer, an indication of one of an MCG leg of a split bearer or an SCG leg of a split bearer, a bearer identifier, a packet data unit session identifier, or a quality of service flow identifier.

Aspect 35: The method of any of Aspects 25-34, wherein the one or more RVQoE configurations includes an MN-specific RVQoE configuration and an SN-specific RVQoE configuration, wherein the MN-specific RVQoE configuration is associated with a first set of one or more RRC identifiers, and wherein the SN-specific RVQoE configuration is associated with a second set of one or more RRC identifiers.

Aspect 36: The method of Aspect 35, wherein the first set of one or more RRC identifiers includes a first RRC identifier, and wherein the second set of one or more RRC identifiers includes a second RRC identifier different than the first RRC identifier.

Aspect 37: The method of Aspect 36, further comprising receiving, from the UE, an RVQoE measurement report associated with the first RRC identifier based at least in part on an application associated with the first RRC identifier being associated with MN connectivity.

Aspect 38: The method of Aspect 36, further comprising receiving, from the UE, an RVQoE measurement report associated with the second RRC identifier with an indication of SN connectivity associated with the RVQoE measurement report based at least in part on an application associated with the second RRC identifier being associated with SN connectivity.

Aspect 39: The method of Aspect 35, wherein the first set of one or more RRC identifiers and the second set of one or more RRC identifiers include a first RRC identifier and a second RRC identifier, and wherein the MN receives from the UE a first RVQoE measurement report associated with first RRC identifier based at least in part on an application associated with the first RRC identifier being associated with MN connectivity, and wherein the MN does not receive from the UE a second RVQoE measurement report associated with the second RRC identifier based at least in part on an application associated with the second RRC identifier being associated with SN connectivity.

Aspect 40: An apparatus for wireless communication at a device, comprising a processor: memory coupled with the processor; and instructions stored in the memory and executable by the processor to cause the apparatus to perform the method of one or more of Aspects 1-24.

Aspect 41: A device for wireless communication, comprising a memory and one or more processors coupled to the memory, the one or more processors configured to perform the method of one or more of Aspects 1-24.

Aspect 42: An apparatus for wireless communication, comprising at least one means for performing the method of one or more of Aspects 1-24.

Aspect 43: A non-transitory computer-readable medium storing code for wireless communication, the code comprising instructions executable by a processor to perform the method of one or more of Aspects 1-24.

Aspect 44: A non-transitory computer-readable medium storing a set of instructions for wireless communication, the set of instructions comprising one or more instructions that, when executed by one or more processors of a device, cause the device to perform the method of one or more of Aspects 1-24.

Aspect 45: An apparatus for wireless communication at a device, comprising a processor: memory coupled with the processor: and instructions stored in the memory and executable by the processor to cause the apparatus to perform the method of one or more of Aspects 25-39.

Aspect 46: A device for wireless communication, comprising a memory and one or more processors coupled to the memory, the one or more processors configured to perform the method of one or more of Aspects 25-39.

Aspect 47: An apparatus for wireless communication, comprising at least one means for performing the method of one or more of Aspects 25-39.

Aspect 48: A non-transitory computer-readable medium storing code for wireless communication, the code comprising instructions executable by a processor to perform the method of one or more of Aspects 25-39.

Aspect 49: A non-transitory computer-readable medium storing a set of instructions for wireless communication, the set of instructions comprising one or more instructions that, when executed by one or more processors of a device, cause the device to perform the method of one or more of Aspects 25-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from at least one of a master node (MN) or a secondary node (SN), one or more radio access network visible quality of experience (RVQoE) configurations, wherein the UE is operating in a dual connectivity mode with the MN and the SN; and
transmit, to at least one of the MN or the SN, at least one RVQoE measurement report based at least in part on the one or more RVQoE configurations.

2. The apparatus of claim 1, wherein the one or more RVQoE configurations includes a common RVQoE configuration received from the MN.

3. The apparatus of claim 1, wherein the one or more RVQoE configurations includes an MN-specific RVQoE configuration and an SN-specific RVQoE configuration.

4. The apparatus of claim 3, wherein the SN-specific RVQoE configuration is based at least in part on a list of available RVQoE configurations provided by the MN to the SN.

5. The apparatus of claim 3, wherein the MN-specific RVQoE configuration and the SN-specific RVQoE configuration are received from the MN.

6. The apparatus of claim 5, wherein the SN-specific RVQoE configuration is based at least in part on configuration information provided to the MN from the SN via an Xn application protocol information element.

7. The apparatus of claim 5, wherein the SN-specific RVQoE configuration is based at least in part on configuration information provided to the MN from the SN via a cell group container.

8. The apparatus of claim 3, wherein the MN-specific RVQoE configuration is received from the MN and the SN-specific RVQoE configuration is received from the SN.

9. The apparatus of claim 8, wherein the SN-specific RVQoE configuration is received from the SN via a signaling radio bearer.

10. The apparatus of claim 8, wherein the MN-specific RVQoE configuration and the SN-specific RVQoE configuration are based at least in part on the UE providing an indication to the MN that a first set of one or more RVQoE configurations are associated with the MN and that a second set of one or more RVQoE configurations are associated with the SN.

11. The apparatus of claim 1, wherein the one or more processors are further configured to:
collect at least one RVQoE metric based at least in part on the one or more RVQoE configurations; and
determine whether each RVQoE configuration is associated with one of MN connectivity or SN connectivity.

12. The apparatus of claim 1, wherein the UE transmits at least one RVQoE measurement report to the MN.

13. The apparatus of claim 12, wherein the at least one RVQoE measurement report includes a first RVQoE measurement report associated with the MN and a second RVQoE measurement report associated with the SN, and wherein the UE transmits, to the MN, at least one of interface information or bearer information indicating that the first RVQoE measurement report is associated with the MN and that the second RVQoE measurement report is associated with the SN.

14. The apparatus of claim 13, wherein the at least one of interface information or bearer information includes at least one of an indication of one of MN connectivity or SN connectivity, an indication of one of a master cell group (MCG) bearer or a secondary cell group (SCG) bearer, an indication of one of an MCG leg of a split bearer or an SCG leg of a split bearer, a bearer identifier, a packet data unit session identifier, or a quality of service flow identifier.

15. The apparatus of claim 1, wherein the at least one RVQoE measurement report includes a first RVQoE measurement report associated with the MN and a second RVQoE measurement report associated with the SN, and wherein the UE transmits the first RVQoE measurement report to the MN and the second RVQoE measurement report to the SN.

16. The apparatus of claim 1, wherein the one or more RVQoE configurations includes an MN-specific RVQoE configuration and an SN-specific RVQoE configuration, wherein the MN-specific RVQoE configuration is associated with a first set of one or more radio resource control (RRC) identifiers, and wherein the SN-specific RVQoE configuration is associated with a second set of one or more RRC identifiers.

17. The apparatus of claim 16, wherein the first set of one or more RRC identifiers includes a first RRC identifier, and wherein the second set of one or more RRC identifiers includes a second RRC identifier different than the first RRC identifier.

18. The apparatus of claim 17, wherein the one or more processors are further configured to at least one of:
report a first RVQoE measurement report associated with the first RRC identifier to the MN based at least in part on an application associated with the first RRC identifier being associated with MN connectivity; or
report a second RVQoE measurement report associated with the second RRC identifier to the SN based at least in part on an application associated with the second RRC identifier being associated with SN connectivity.

19. The apparatus of claim 17, wherein the one or more processors are further configured to at least one of:
drop reporting of a first RVQoE measurement report associated with the second RRC identifier based at least in part on an application associated with the second RRC identifier being associated with MN connectivity; or
report the first RVQoE measurement report associated with the second RRC identifier to the MN with an indication of SN connectivity associated with the RVQoE measurement report based at least in part on an application associated with the second RRC identifier being associated with SN connectivity.

20. The apparatus of claim 16, wherein the first set of one or more RRC identifiers and the second set of one or more RRC identifiers includes a first RRC identifier.

21. The apparatus of claim 20, wherein the one or more processors are further configured to transmit, from an access stratum layer of the UE to an application layer of the UE, the MN-specific RVQoE configuration based at least in part on the first set of one or more RRC identifiers and the second set of one or more RRC identifiers including the first RRC identifier.

22. The apparatus of claim 20, wherein the one or more processors are further configured to transmit, from an access stratum layer of the UE to an application layer of the UE, a latest-received RVQoE configuration of the MN-specific RVQoE configuration or the SN-specific RVQoE configuration based at least in part on the first set of one or more RRC identifiers and the second set of one or more RRC identifiers including the first RRC identifier.

23. The apparatus of claim 20, wherein the one or more processors are further configured to:
transmit, from an access stratum layer of the UE to an application layer of the UE, the MN-specific RVQoE configuration and the SN-specific RVQoE configuration based at least in part on the first set of one or more RRC identifiers and the second set of one or more RRC identifiers including the first RRC identifier; and
determine whether to use the MN-specific RVQoE configuration and the SN-specific RVQoE configuration based at least in part on a connectivity of an application associated with the first RRC identifier.

24. The apparatus of claim 16, wherein the first set of one or more RRC identifiers and the second set of one or more RRC identifiers include a first RRC identifier and a second RRC identifier, wherein the UE reports a first RVQoE measurement report associated with first RRC identifier to the MN based at least in part on an application associated with the first RRC identifier being associated with MN connectivity, and wherein the UE reports a second RVQoE measurement report associated with the second RRC identifier to the SN based at least in part on an application associated with the second RRC identifier being associated with SN connectivity.

25. An apparatus for wireless communication at a master node (MN) for wireless communication, comprising:
a memory; and
one or more processors, coupled to the memory, configured to:
transmit, to a user equipment (UE), one or more radio access network visible quality of experience (RVQoE) configurations, wherein the UE is operating in a dual connectivity mode with the MN and a secondary node (SN); and
receive, from the UE, at least one RVQoE measurement report based at least in part on the one or more RVQoE configurations.

26. The apparatus of claim 25, wherein the at least one RVQoE measurement report includes a first RVQoE measurement report associated with the MN and a second RVQoE measurement report associated with the SN, and wherein the MN receives, from the UE, at least one of interface information or bearer information indicating that the first RVQoE measurement report is associated with the MN and that the second RVQoE measurement report is associated with the SN.

27. A method of wireless communication performed by a user equipment (UE), comprising:
receiving, from at least one of a master node (MN) or a secondary node (SN), one or more radio access network visible quality of experience (RVQoE) configurations, wherein the UE is operating in a dual connectivity mode with the MN and the SN; and
transmitting, to at least one of the MN or the SN, at least one RVQoE measurement report based at least in part on the one or more RVQoE configurations.

28. The method of claim 27, further comprising:
collecting at least one RVQoE metric based at least in part on the one or more RVQoE configurations; and
determining whether each RVQoE configuration is associated with one of MN connectivity or SN connectivity.

29. A method of wireless communication performed by a master node (MN), comprising:
transmitting, to a user equipment (UE), one or more radio access network visible quality of experience (RVQoE) configurations, wherein the UE is operating in a dual connectivity mode with the MN and a secondary node (SN); and
receiving, from the UE, at least one RVQoE measurement report based at least in part on the one or more RVQoE configurations.

30. The method of claim 29, wherein the at least one RVQoE measurement report includes a first RVQoE measurement report associated with the MN and a second RVQoE measurement report associated with the SN, and wherein the MN receives, from the UE, at least one of interface information or bearer information indicating that the first RVQoE measurement report is associated with the MN and that the second RVQoE measurement report is associated with the SN.
